(19) United States
(12) Patent Application Publication
(10) Pub. No.: US 2026/0066638 A1
(43) Pub. Date: Mar. 5, 2026

(54) WATERPROOF CABLE GLAND

(71) Applicant: OCEAN VISION ENVIRONMENTAL RESEARCH PTY LTD, Bayswater (AU)

(72) Inventors: Matthew James HARVEY, Bayswater (AU); Nicholas James DOBSON, Mont Albert North (AU)

(21) Appl. No.: 19/132,655

(22) PCT Filed: Nov. 27, 2023
(86) PCT No.: PCT/AU2023/051215

§ 371 Date: May 23, 2025

(30) Foreign Application Priority Data
Nov. 26, 2022 (AU) 2022903585

(51) Int. Cl. H02G 15/013; H02G 3/04; H02G 3/06; H02G 3/08; H02G 15/06; H02G 15/18

(52) U.S. Cl. CPC H02G 15/013; H02G 3/0437; H02G 3/0625; H02G 3/083; H02G 3/088; H02G 15/06; H02G 15/18

(57) ABSTRACT

A cable gland has first and second parts, which are mutually engageable, and a seal assembly that is housed within and between the first and second parts. The seal assembly has at least one carrier on each side of a cable seal. Each carrier seats a respective body seal. Each cable seal has an opening through which a cable can pass. In use the cable seal forms a seal about the cable. Each body seal is arranged to form a respective seal against the inner surface of the first. The cable seals provide water ingress protection about the cable, while the body seals provide water ingress protection between the inside of the first part and the seal assembly. The parts and, when engaged, are configured to apply a longitudinal compression to the seal assembly. This results in the carriers squeezing the cable seal therebetween into sealing contact with and about an outer surface of the cable. This, in combination with the action of the body seals provides water ingress protection.

### TECHNICAL FIELD

The present disclosure relates to a waterproof cable gland.

### BACKGROUND ART

A cable gland is a mechanical assembly of parts used to act as a seal about a cable when securing the cable to a junction box. In a common application a cable gland may mechanically secure a cable to a junction box in which the cable may be attached to other cables or connectors. In addition to providing ingress protection, a cable gland also increases the pull-out resistance of the cable and can provide mechanical support to minimise material fatigue in the cable.

Ingress protection against water may be provided by washers at one or more locations along and/or within the gland. The washers may be subject to radial compression on the cable over a contact area about a portion of the gland.

For the purposes of compliance with safety and environmental regulations, equipment and assemblies may need to meet a prescribed ingress protection (IP) rating. The rating is designated as “IP XY” where X is an integer between 0 and 6 indicating a solids (e.g., dust) ingress protection rating, and Y is an integer between 0 and 8 indicating a liquids ingress protection rating.

For underwater or other wet environment applications a cable gland may need an IP rating of IP X8 which means that the gland provides ingress protection from long term (i.e., continuous) immersion under water for depths greater than 1 m, up to a specified pressure or depth of water.

The above references to the background art do not constitute an admission that the art forms a part of the common general knowledge of a person of ordinary skill in the art. The above references are also not intended to limit the application of the disclosed waterproof cable gland to any particular form of the waterproof cable gland.

### SUMMARY OF THE DISCLOSURE

The general idea of the disclosed cable gland is to provide a waterproof cable gland that permits the entry, in particular and without limiting the field of application, of electrical power, instrumentation and/or control cables into waterproof enclosures whilst not compromising the waterproofing of said enclosures.

The degree of waterproofing provided by the disclosed gland may vary with the particular intended end-use application. Nevertheless at least some of the embodiments of disclosed waterproof cable glands seek to provide an ingress protection rating of IP68. Throughout this specification, including the claims, the reference to a “waterproof” cable gland does not exclude that the possibility that the waterproof cable gland may also provide dust ingress protection. For example, embodiments of the waterproof cable gland may have a dust rating or 5 or 6.

In a first aspect there is disclosed waterproof cable gland comprising:
a first part and a second part, the first and second parts being mutually engageable; and
a seal assembly arranged to be housed between the first and second parts, the seal assembly having at least one cable seal and at least two body seals, on one either side of the cable seal, the at least one cable seal having an opening through which a cable running through the gland can pass, and each of the at least two body seals arranged to form respective seals against an inner surface of the first part;
wherein the first and second parts are configured to apply a longitudinal compression to the seal assembly when engaged and the longitudinal compression acts to deform the at least one cable seal into sealing contact with and about an outer surface of a cable running through the gland.

In one embodiment each carrier has an outer circumferential groove for seating a respective body seal and at least one compression surface arranged to apply the longitudinal compression to an adjacent cable seal.

In one embodiment the compression surfaces of mutually adjacent carriers between which a respective cable seal is located are relatively configured so that application of the longitudinal compressive force causes the compression surfaces of mutually adjacent carriers preferentially to compress the cable seal in a generally radially inward direction onto and surrounding the cable passing through the opening.

In one embodiment facing compression surfaces of mutually adjacent carriers are configured to form a cavity for a respective cable seal, wherein the cavity has a radially outer gap and a radially inner gap wherein the radially inner gap has a greater longitudinal length than the radially outer gap.

In one embodiment at least one compression surface in a pair of mutually adjacent carriers is bevelled or sloped.

In one embodiment the respective mutually facing compression surfaces in a pair of mutually adjacent carriers are bevelled or sloped in a manner to converge toward each other in a direction away from the cable.

In one embodiment each carrier is provided with a plurality of grooves or recesses for engaging a tool arranged to facilitate removal of the carriers from the first part.

In one embodiment the waterproof cable gland includes a split clamp operable to grip on the cable.

In one embodiment split clamp is provided with tapered surfaces on opposite axial ends arranged to engage the gland body on one side and a carrier on the opposite side.

In a second aspect there is disclosed a method of forming a waterproof cable gland comprising:
locating a seal assembly having plurality of rigid carriers and one or more cable seals onto a cable, wherein at least one cable seal is located between mutually adjacent carriers and at least the carriers between which the at least one cable seal is located, seat respective body seals;
housing the seal assembly in and between first and second mutually engageable parts; and longitudinally compressing the seal assembly by engaging the first and second mutually engageable parts to squeeze the at least one cable seal on to and circumferentially about the cable to form a substantial seal about the cable preventing the ingress of particles or fluid along the cable and through the gland.

In one embodiment the method includes squeezing the at least one cable seal onto the cable with sufficient force wherein the at least one cable seal frictionally grips the cable to resist a pull-out force applied to the cable.

In a third aspect there is disclosed a front mount system comprising a module and a housing, the module being connectable to the housing, wherein the housing contains one or more housing components and associated housing component connectors;
the housing having a recess that opens onto the external surface and surrounds the one or more connectors;
a circumferential channel formed in the recess and inboard of the external surface;
the module having a module body containing a module component and one or more connectors of the module component, the module body and the recess relatively configured to enable the module to be inserted into the recess by way of relative linear motion when the module is in a specific rotational orientation relative to the housing to connect the one or more connectors of the module component with the one or more connectors of the housing component; and
a locking arrangement configured to engage both the channel and the module when the connectors of the module component and the housing component are connected together, the locking arrangement acting to resist withdrawal of the module from the housing.

In one embodiment the locking arrangement comprises a ring arranged to be located about the module body and having one or more locking surfaces configured to locate within the channel.

In one embodiment the ring and the module body are relatively configured to prevent relative rotational motion between the ring and the module body when the ring is located about the module body.

In one embodiment the locking arrangement comprises a cage, the cage configured to snap fit into the channel and engage with the locking surfaces.

In one embodiment the cage includes an inner structure and an outer structure spaced from the inner structure.

In one embodiment the outer structure is resiliently deformable enabling: flexing of the outer Structure toward and away from the inner structure; and snap fitting of the cage in the channel.

In one embodiment the outer structure is configured to resiliently deform to enable snap fitting of the locking arrangement within the channel.

In one embodiment the ring is configured to be received between the inner and outer structures.

In one embodiment the locking surfaces engage with the outer structure.

In one embodiment the ring is dimensioned to prevent the outer structure from flexing toward the inner structure when the locking surfaces engage with the outer structure to an extent that would enable the cage to escape the channel, thereby locking the cage in the channel.

In one embodiment one or both of the ring and cage is a sacrificial component arranged to break on application of a tensile force of a magnitude greater than a threshold breaking force.

In a further aspect there is disclosed a field serviceable waterproof connector comprising:
a connector body;
a contact carrier configured to sealing fit within the connector body, the contact carrier provided with a plurality of through holes;
a plurality of contacts, each contact receivable in a respective through hole; and respective seal arrangements which form a water tight seal between each contact and an inner surface of a corresponding through hole.

In one embodiment the contact carrier and the connector body are relatively configured to form a press fit therebetween, the press fit providing the sealing fit between the contact carrier and the connector body.

In one embodiment the contact carrier has an outer surface and is provided with one or more O-ring seals about the outer surface arranged to form the sealing fit against an inner surface of the connector body.

In one embodiment the connector body has a front end and a back end and the front end includes an internal stop or lip against which the contact carrier can abut when inserted from the back end.

In one embodiment the field serviceable waterproof connector comprises a spacer locatable within the connector body adjacent the contact carrier, the spacer arranged to allow passage of one or more conductors for connection with the contacts.

In one embodiment the field serviceable waterproof connector comprises a lock plate arranged to lock the contact carrier and the connectors within the connector body.

### BRIEF DESCRIPTION OF THE DRAWINGS

Notwithstanding any other forms which may fall within the scope of the waterproof cable gland as set forth in the Summary, specific embodiments will now be described, by way of example only, with reference to accompanying drawings in which:

FIG. 1a is a schematic representation of a longitudinal section of a first embodiment of the disclosed waterproof cable gland in a partially assembled state prior to longitudinal compression of an associated seal assembly;

FIG. 1b shows the waterproof cable gland of FIG. 1a in a fully assembled state with the associated seal assembly subjected to longitudinal compression;

FIG. 2a-2d are exploded views of the cable gland and associated seal assembly shown in FIGS. 1a and 1b;

FIG. 2e is an isometric view of an alternate form of carrier that may be incorporated in embodiments of the disclosed seal assembly and cable gland;

FIGS. 3a-3c are schematic representations showing a cutaway view, an exploded view and an assembled view, respectively of a second embodiment of the disclosed cable gland;

FIGS. 4a-4c are schematic representations showing an exploded view, a cutaway view, and an assembled view, respectively of a third embodiment of the disclosed cable gland;

FIGS. 5a-5b are schematic representations showing an exploded view and a cutaway assembled view, respectively of a fourth embodiment of the disclosed cable gland;

FIGS. 6a-6c are schematic representations showing an assembled view, a cutaway view, and exploded view, respectively of a fifth embodiment of the disclosed cable gland;

FIGS. 7a-7b are schematic representations showing one form of blanking plug that may be used with a gland body and nut of an embodiment of the disclosed gland in place of a cable;

FIGS. 8a-8c are schematic representations showing a second form of blanking plug that may be used with a gland body and nut of an embodiment of the disclosed gland in place of a cable;

FIGS. 9a-9d are schematic representations of one form of cable seal that may be used in embodiments of the disclosed cable gland;

FIGS. 10a-10d are schematic representations of another form of cable seal that may be used in embodiments of the disclosed cable gland;

FIGS. 11a-11c are schematic representations of one form of cable relief insert that may be incorporated in embodiments of the disclosed cable gland;

FIGS. 12a-12c are schematic representations of a second form of cable grip insert that may be incorporated in embodiments of the disclosed cable gland;

FIGS. 13a and 13b depict embodiments of the disclosed cable gland used in conjunction with a Y shaped junction box;

FIGS. 14a-14c are schematic representations of a further embodiment of the disclosed cable gland suitable for accommodating multiple cables and associated seal assemblies;

FIGS. 15a-15c are schematic representations of yet a further embodiment of the disclosed cable gland;

FIGS. 16a, 16b, 16c and 16d are representations of an embodiment of a front mount system having a housing and one or more connectable modules. The front mount system may incorporate aspects of, or be used with, the disclosed cable gland. FIG. 16a is an exploded view, FIG. 16b is a front view, FIG. 16c is a side view and FIG. 16d is a top view, of the front mount system;

FIGS. 16e-16g illustrate embodiments of the front mount system with key arrangements in the form of flat surfaces that co-operate with flat surfaces on modules used in the front mount system to ensure correct rotational alignment of modules connected in the front mount system;

FIG. 17a is a section view of a front plate of the front mount system shown in FIGS. 16a and 16b;

FIG. 17b is a section view through the front plate and a connected module the front mount system shown in FIG. 16a-16d;

FIGS. 18a, 18b, and 18c are bottom, side and top views respectively of a ring which forms part of a locking arrangement incorporated in one or more embodiments of the front mount system;

FIGS. 19a, 19b, and 19c are bottom, side and top views respectively of a cage which forms part of a locking arrangement incorporated in the front mount system;

FIGS. 20a and 20b are perspective views from opposite sides of the ring and cage of FIGS. 18a-19c which together form the locking arrangement incorporated in the front mount system, prior to engagement;

FIG. 21 is a perspective view of the locking arrangement when the ring and cage are engaged with each other;

FIGS. 22a and 22b are end and section views of the locking arrangement when the ring and cage are engaged with each other;

FIG. 23a, is a perspective view from a first angle of a second form of ring that may be used in a locking arrangement of the front mount system;

FIG. 23b is a section view of the ring shown in FIG. 23a;

FIG. 23c is a perspective view from a second angle of the second form of the ring shown in FIG. 23a;

FIG. 24a is an exploded view of a waterproof connection system incorporating embodiments of the disclosed waterproof cable gland, front mount system, and a field serviceable waterproof connector;

FIG. 24b is a perspective exploded view of the waterproof connection system shown in FIG. 24a;

FIG. 25a, is a partial section view of the field serviceable waterproof connector shown in FIGS. 24a and 24b;

FIG. 25b is a full section view of the field serviceable waterproof connector shown in FIGS. 24a and 24b;

FIG. 25c is an end view of the field serviceable waterproof connector shown in FIGS. 24a and 24b;

FIGS. 26a and 26b are exploded views from different perspectives of an alternate field serviceable waterproof connector;

FIGS. 27a, 27b and 27c are side, section and end views respectively of the field 5 serviceable waterproof connector shown in FIGS. 26a and 26b;

FIGS. 28a and 28b depict a possible variation the configuration and structure of contacts used in the field serviceable waterproof connector shown;

FIG. 29a is a section view of a module in the form of a button activated switch useable with an embodiment of the front mount system;

FIG. 29b is a section view of a module in the form of a LED indicator useable with an embodiment of the front mount system;

FIGS. 29c-29f are: a front perspective view, a rear perspective view, front view and side view respectively of a portion of a front plate of a housing of a front mount system in which one of the modules of FIG. 29a or 29b is installed;

FIGS. 30a-30d are schematic representations showing an exploded view of a sixth embodiment of the disclosed cable gland; and

FIGS. 31a-31b are schematic representations showing an exploded view of a seventh embodiment of the disclosed cable gland.

### DETAILED DESCRIPTION OF SPECIFIC EMBODIMENTS

Specific embodiments of the disclosed waterproof cable gland will now be described by way of example only. The terminology used herein is for the purpose of describing particular embodiments only and is not intended to limit the scope of the disclosed waterproof cable gland. Unless defined otherwise, all technical and scientific terms used herein have the same meanings as commonly understood by one of ordinary skill in the art to pertaining to waterproof cable gland. In the drawings like reference numbers refer to like parts.

In the following description multiple embodiments of the disclosed waterproof cable gland are described. Specific embodiments are designated as 10a-10h. However, the expression “gland 10, or glands 10”, are used in a general sense to refer to any embodiment of the disclosed cable glands.

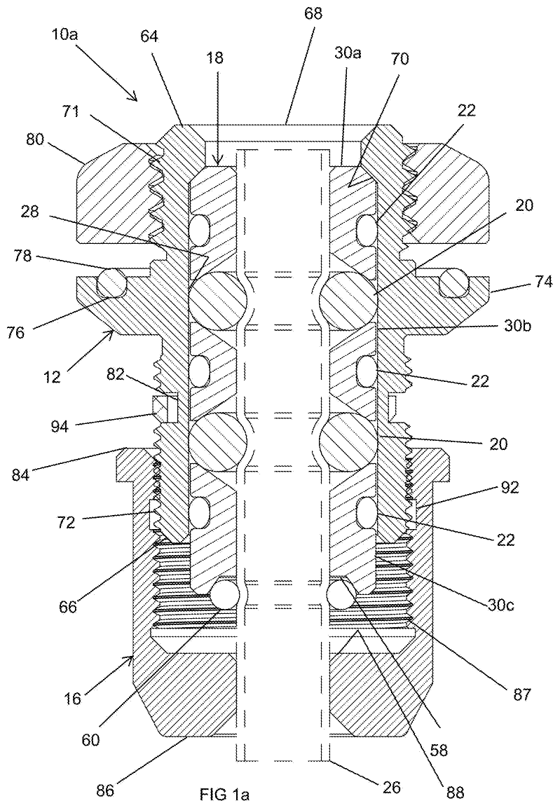

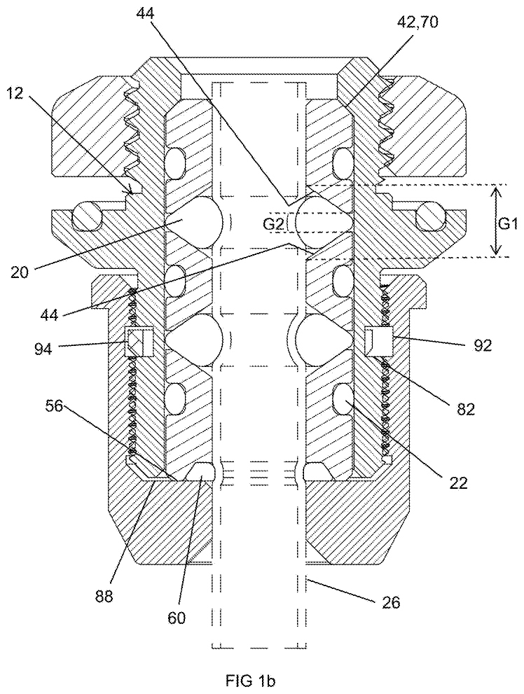

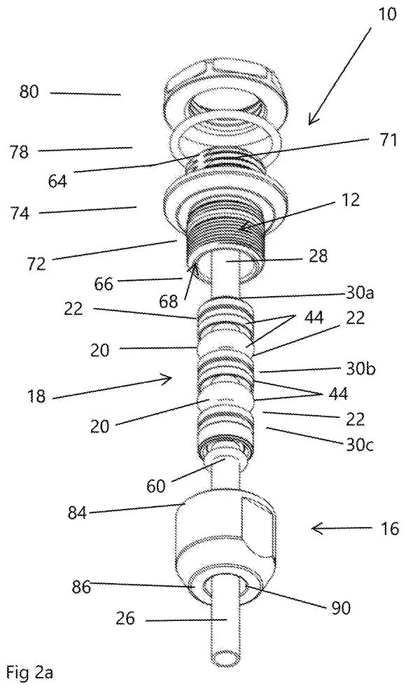

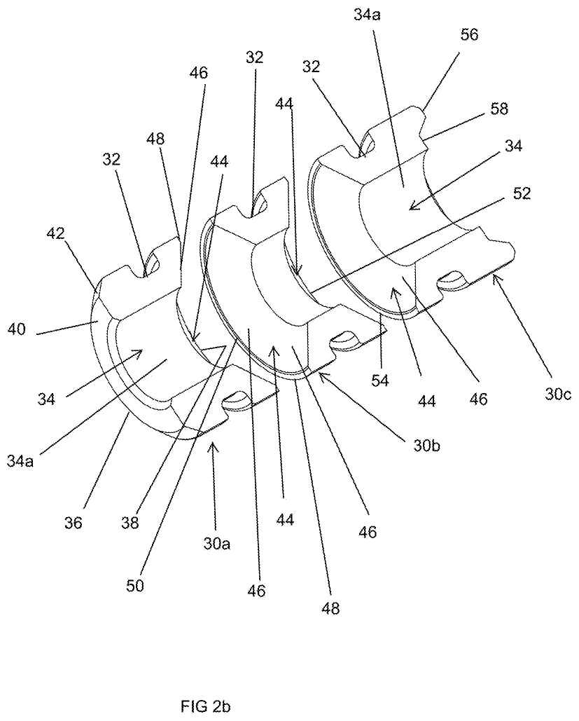

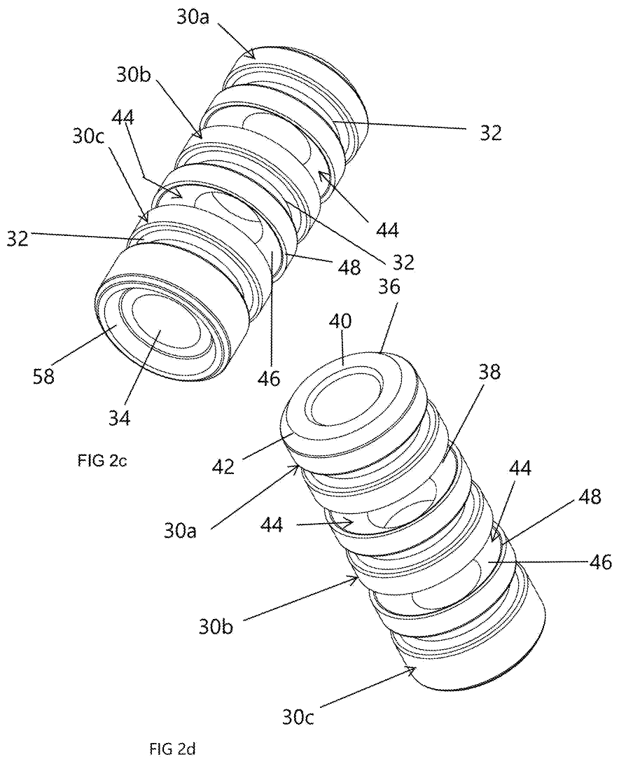

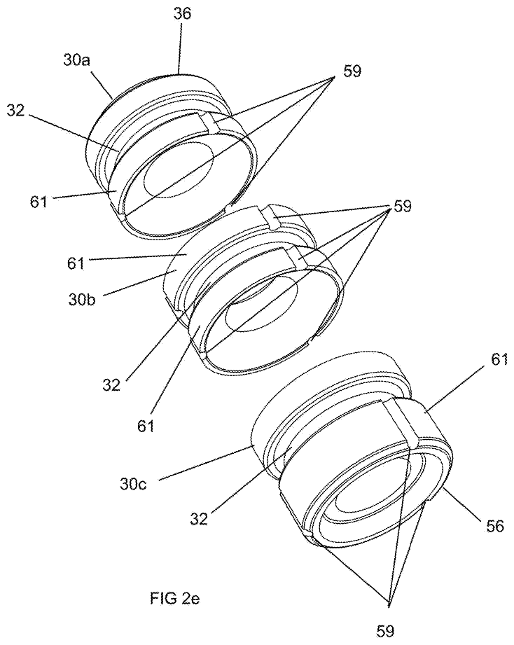

With reference to FIGS. 1a, 1b and 2a-2d a first embodiment of the disclosed cable gland 10a (hereinafter referred to as “gland 10a”) comprises first and second parts 12, 16 which are mutually engageable, and a seal assembly 18 that is housed within and between the first and second parts 12, 16. The seal assembly 18 has at least one carrier 30a, 30b, 30c (hereinafter referred to in general as “carrier 30” in the singular or “carriers 30” in the plural) on each side of a cable seal 20. Each carrier 30 seats a respective body seal 22. The first part 12 may also be termed, and hereinafter may also be referred to as, “gland body 12”.

The second part 16 in this embodiment takes the form of and may also be referred to as, “nut 16”.

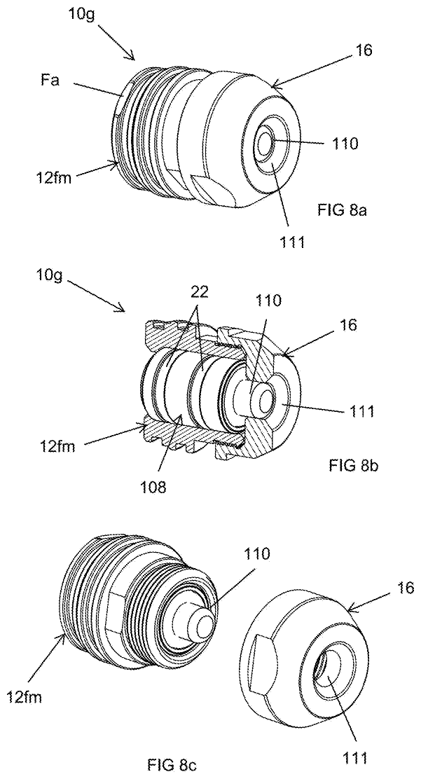

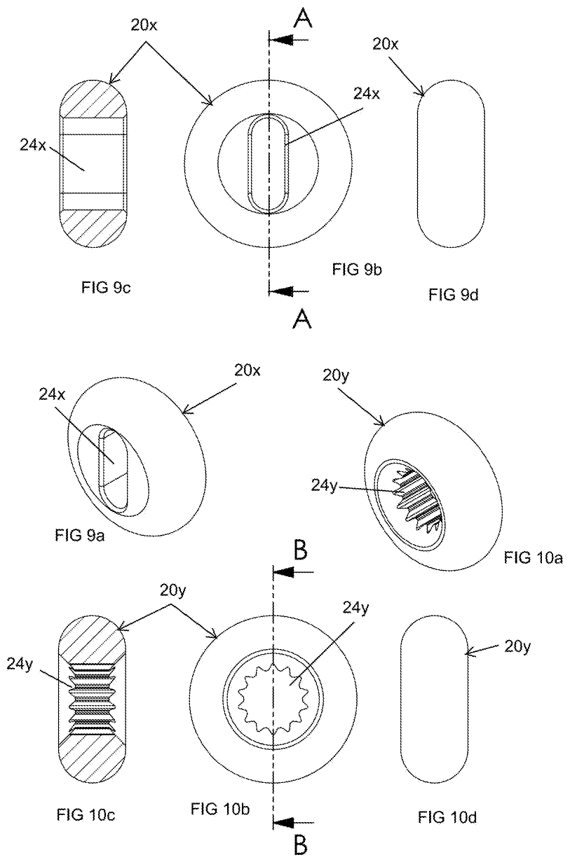

Each cable seal 20 has an opening 24 (shown in FIGS. 9a-10b) through which a cable 26 can pass. In use the cable seal 20 forms a substantial seal about the cable 26. In this, but not all, embodiments the cable seal 20 contacts an inner surface 28 of the gland body 12. Each body seal 22 is arranged to form a respective seal against the inner surface 28 of the gland body 12. The body seals 22 are in the form of O-rings made from a resilient material. Thus, the cable seals 20 provide water ingress protection about the cable 26, while the body seals 22 provide water ingress protection between the inside of the gland body 12 and the seal assembly 18.

Therefore, when the gland 10a is fully assembled and the seal assembly 18 is activated by the application of longitudinal compression, ingress of fluid and/or particles is prevented along the cable 26 and through the gland 10a. Additionally, the compression applied by the cable seals 20 onto the cable 26 acts to retain the cable 26 within the gland 10a against externally applied pull-out forces.

The gland body 12 and nut 16 are configured to apply a longitudinal compressive force to the seal assembly 18. This compressive force squeezes each cable seal 20 into sealing contact with and about an outer surface of a cable 26 running through the gland 10a.

Looking at the gland 10a in more detail, the seal assembly 18 includes a plurality of carriers 30, and specifically in this embodiment there are three carriers 30a, 30b and 30c. There is a body seal 22 supported on each carrier 30. The carriers 30 are in the form of a disk or squat cylinder with an outer circumferential groove 32 for seating a respective body seal 22. The body seals 22 are fitted on each carrier both to (i) position the carriers 30 centrally in the bore (and reduce risk of scratching the bore) and (ii) to provide redundancy in the multi-stage sealing against the bore. Each carrier also has a hole 34 through which a cable 26 can pass. The carriers are made of a rigid material such as but not limited to a metal or metal alloy, or a hard plastics material. The grooves 32 are inboard of the axially opposite ends of each carrier 30. In the depicted embodiments the hole 34 has a circumferential surface portion 34a of constant diameter. The surface portion 34a may extend for an axial length at least to opposite axial ends of the groove 32.

With particular reference to FIGS. 2b-2d it can be seen that the carriers 30a, 30b and 30c have different shape and configuration to each other. The carrier 30a has axially opposite ends 36 and 38. The end 36 has a surface 40 that lies in a radial plane and extends for a portion of the radius of the carrier 30a; and a continuous bevelled surface 42. The end 38 is formed with a compression surface 44 which in use applies a compression force to an adjacent cable seal 20. The compression surface 44 has a bevelled or sloping surface portion 46 of progressively increasing diameter that is contiguous with the hole 34 of the carrier 30a. An outer annular rim 48 circumscribes the bevelled surface portion 46 and lies in a radial plane.

When two compression surfaces 44 face each other along a common axis they converge toward each other as the radial distance from the hole 34 increases. So, the distance between two facing compression surfaces 44 is at a minimum at their respective rims 48 and a maximum at the circumferential edge of their holes 34. In the absence of an intervening body seal 22, two mutually facing compression surfaces 44 would abut at their rims 48 and form a cavity that, together with the outer surface of the cable 26, has in any axial cross section a shape of an isosceles triangle. Thus, as longitudinal (i.e., axial) compression is applied to the seal assembly 18 the compression surfaces 44 apply greater pressure to an intervening cable seal 20 as radial distance from the hole 34 increased. So, in effect the carriers 30/compression surfaces 44 tend to squeeze the cable seals 20 in a generally radial inward direction onto and about the cable 26.

The effect of the configuration of the compression surfaces 44 on the cable seals 20 when the seal assembly 18 is longitudinally compressed is visible in a comparison between FIGS. 1a and 1b. When there is no longitudinal compression the cable seals 20 have a circular cross-sectional shape as shown in FIG. 1a. When longitudinal compression is applied to the seal assembly 18, the cable seals 20 are forced or distorted into the shape of a triangle with rounded corners, similar toa teardrop with the base pressing against the cable 26 and the apex near, but not necessarily touching, the inside surface of the gland body 12. The carrier 30b has axially opposite ends 50 and 52. Each end 50, 52 has a compression surface 44 of the same shape and configuration as the compression surface 44 at the radial end 38 of the carrier 30a.

The carrier 30c has opposite axially ends 54 and 56. The end 54 has a compression surface 44 of the same shape and configuration as the compression surface 44 at the end 38 of the carrier 30a. The end 56 has an optional circumferential groove 58 for seating an anti-rotation seal 60.

In one variation, and as shown in FIG. 2e embodiments of the carriers 30 may be provided with a plurality of axial grooves 59 formed in and spaced about their outer circumferential surfaces 61. The grooves 59 are provided to receive prongs of a tool that can be used for removing the carriers 30 from a gland body 12. In an alternative arrangement a plurality of grooves or recesses may be formed on the inner circumferential surfaces of the carriers 30 to receive or otherwise engage with an extraction tool. The provision of grooves or recesses on the carriers 30 is purely optional and does not affect the operation of the carriers 30 and more particularly the seal assembly 18 in providing watertight seals against the outer circumference of the cable 26 and the inner surface of the gland body 12.

It should be noted in FIG. 2e that the grooves 59 are provided on the outer circumferential surface 61 on both sides of the groove 32 for the carrier 30b, but on one side only of the grooves 32 for the carriers 30a and 30c. This is because carrier 30b is bidirectional in the sense that it can be inserted either end first into the gland body 12. In contrast the carriers 30a and 30c are “directional” in that the carrier 30a is inserted with end 36 first, and the carrier 30b is inserted with its end 56 facing outwardly of the gland body 12. In this way, the grooves 59 also provide visual assistance for the correct assembly of the cable gland 10.

The gland body 12 is in the general form of a tube with opposite ends 64 and 66 and a longitudinal passage 68. The inner surface 28 of the body 12, which forms the passage 68, has an abutment surface 70 (FIGS. 1a, 1b) near and inboard of the end 64. In this embodiment the abutment surface 70 is formed with a progressively reducing inner diameter when looking in a direction toward the first end 64 from the second end 66. Other than the abutment surface 70, the inner surface 28 is of a constant diameter for the remainder of the length of the passage 68.

The outer surface of the gland body 12 is formed with engagement mechanisms 71 and 72 (FIG. 2a) near the ends 64 and 66 respectively. In this embodiment both the engagement mechanisms are in the form of screw threads. The gland body 12 also has a radially extending flange 74 intermediate of the engagement mechanisms 71, 72. A groove 76 is formed in a radial surface of the flange 74 facing toward end 64. The groove 76 seats an O-ring seal 78. A screw nut 80 can engage the thread 71. This can be used to fasten the gland 10a to say a wall of a junction box or control panel, with the flange 74 and nut 80 on opposite sides of the wall. Between the flange 74 and the end 66 there is a circumferential groove 82 formed on the outside surface of the gland body part 12. A sacrificial split locking ring 94 is seated in the groove 82.

The second part/nut 16 is in the form a screw nut with opposite ends 84 and 86, and an internal thread 87 for engaging the thread 72. The end 86 is formed with an internal abutment surface 88. The abutment surface 88 has a hole 90 that is coaxial with the passage 68 and through which the cable 26 passes. A groove 92 is formed in the inner circumferential surface of the nut 16.

As most clearly seen in FIG. 1b the compression surfaces 44 of mutually adjacent carriers 30 are relatively configured so that on the application of a longitudinal compressive force, the compression surfaces preferentially compress the cable seal 20 in a generally radially inward direction onto and about the cable 26 passing therethrough. Another way of looking at this is to consider the facing compression surfaces 44 of mutually adjacent carriers 30 as forming a cavity for a respective cable seal 20. The cavity has radially inner gap G1 (see FIG. 1b) and a radially outer gap G2. The radially inner gap G1 has a greater longitudinal length than the radially outer gap G2. So, when the seal assembly is longitudinally compressed the cable seals 20 preferentially deform to move into the larger gap G1.

The gland 10a is initially installed as separate component parts onto the cable 26. A practical assembly sequence would be:
1. Install gland body 12 and O-ring seal 78, placing the gland body 12 into a hole in, and from an outside of, an enclosure wall, so that the seal 78 is adjacent the outside of the enclosure wall, then secured with nut 80 screwing onto thread 71.
2. Place the gland components onto one end of a cable 26 in the following order:
   (i). gland nut 16, anti-rotational seal 60, seal assembly 18 including the cable seals 20 (with end 56 first and end 54 last);
   (ii) locking ring 94.
3. Insert an opposite end of the cable 26 through the gland body 12 into the enclosure (with sufficient length to terminate the cable wires as required).
4. Insert the seal assembly 18 into the gland body 12, sliding it along the cable.
5. Place the anti-rotational seal 60, sliding it along the cable.
6. Slide the gland nut 16 along the cable, engage the gland nut thread 87 with gland body thread 72 and tighten as required.

As the nut 16 is tightened eventually the seal assembly 18 becomes compressed between the gland body 12 and the nut 16. More specifically, and with reference to FIG. 1b, the surface 42 of the carrier 30a comes into contact with the abutment surface 70, while the anti-rotation seal 60 and subsequently the end 56 of the carrier 30c come into contact with the abutment surface 88. Further tightening of the nut applies a longitudinal compression force on the cable seals 20. This compression force results in deformation of the cable seals 20 in radially opposite directions. The deformation is preferentially in a radial inward direction, squeezing the cable seals 20 into sealing contact onto and about the cable 26 passing through their respective openings. The preferential radial inward compression arises from the shape and configuration of the compression surfaces 44.

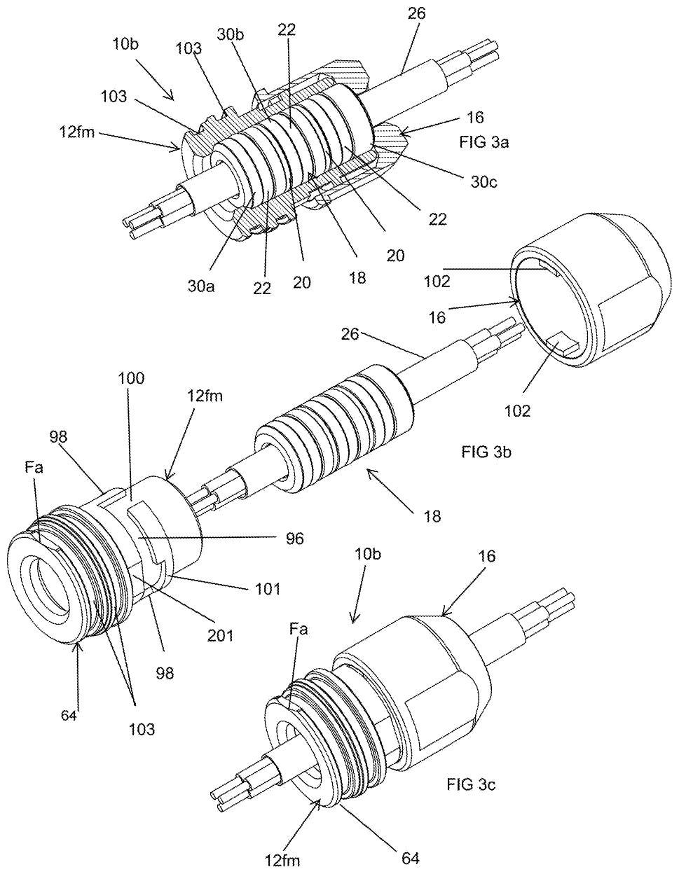

FIGS. 3a-3c illustrate a second embodiment of the gland designated here as 10b. The only difference between the glands 10a and 10b reside in:
the replacement of the engagement mechanism/thread 72 on the gland body 12 and thread 87 on the nut 16 with a cam lock mechanism; and
modification of the end 64 of the gland body to facilitate coupling using a front mount system, described in detail later, in place of the flange 74, seal 78, thread 71 and nut 80. The gland body with modified end 64 for use with the front mount system is denoted thought this specification as body 12fm.

In the gland 10b the seal assembly 18 has three carriers 30a-30c with corresponding body seals 22, and two intervening cable seals 20. This is identical to the seal assembly of the first embodiment of the gland 10a.

The cam lock mechanism comprises: (a) cam surfaces or channels 96 (only one visible) that run circumferentially about the outer surface of the gland body 12fm from respective openings 100 to corresponding closed ends 98; and (b) cams or keys 102 formed on the inside surface of the nut 16. The keys 102 can be pushed into the openings 100 when they are axially aligned. Thereafter turning the gland body 12fm relative to the nut 16 about a longitudinal axis in one direction causes the keys to ride in the channels 96 toward the closed ends 98. A small notch 101 is cut or otherwise formed in each channel 96 to seat the keys 102. The engagement of the keys 102 in the notches 101 prevents unintentional decoupling of the nut 16 from the gland body 12fm. The cam lock mechanism is arranged so that when the keys are I in the notches 101 the seal assembly is compressed longitudinally between the gland body 12fm and nut 16 so that the cable seals 20 form a substantial seal about the cable 26. This compression also biases the key into the notches preventing unintentional decoupling.

To decouple the gland body 12fm from the nut 16, additional force is applied to push the nut 16 and gland body 12fm toward each other to lift the keys form the notches 101. This is accompanied by a rotational force sliding the keys 102 along the channels toward the openings 100.

The degree of rotation required to operate the cam lock mechanism can be set during the manufacture/production of the gland 10b by the number and location of the notches in the channels, and keys 102 on the nut 16. In some embodiments there may just a single notch 101 and key 102, in other embodiment there may be three or more. When there are two or more channels and keys they may be equally circumferentially spaced and arranged to simultaneously register with respective openings and notches when the body 12fm and nut 16 are moved between decoupled and coupled states.

The cam lock mechanism incorporated in the gland 10b provides an integrated anti-rotation lock action, (i.e., not needing a separate snap locking ring 94) at full compression which prevents the possibility of gland 10b coming open in high vibration environments. In addition, cam lock mechanism may:
make the gland 10b easier to use in situations that require regular access to the gland; and/or
provide more stable or reliable ingress protection for installations where regular and constant cable articulation can often cause traditional gland to loosen over time.

The end 64 of the gland body 12fm is provided with circumferential grooves 103. These are for receiving respective O-rings to form a water tight seal in the front mount system described later in this specification. The gland body is also provided with a flat surface Fa at the front of end 64 and flat surfaces 201 on its outer surface between an inner most of the grooves 103 and the end 66.

FIGS. 4a-4c show a further embodiment of the gland 10c in which the coupling mechanism between the gland body 12fm and the nut 16 is in the form of a press fit. Here, the nut 16 is press fitted onto the end 66 of the gland body 12fm. Ingress protection between the nut 16 and the gland body 12fm is provided for by way of O-ring seals 104 which are seated in respective grooves formed about the gland body 12fm near the end 66. The form and function of the seal assembly 18 is unchanged. The seal assembly 18 is longitudinally compressed by the action of press fitting the gland body 12fm and the nut 16 together. The provision of a press fit has the possible benefits of being tamperproof and fully locked. The press fit may be suited to installations where regular and constant cable articulation can often cause traditional glands to loosen over time. This embodiment may also be suitable for hygienic applications with the ability to provide fully smooth external surfaces with no unsealed cavities for material to build up.

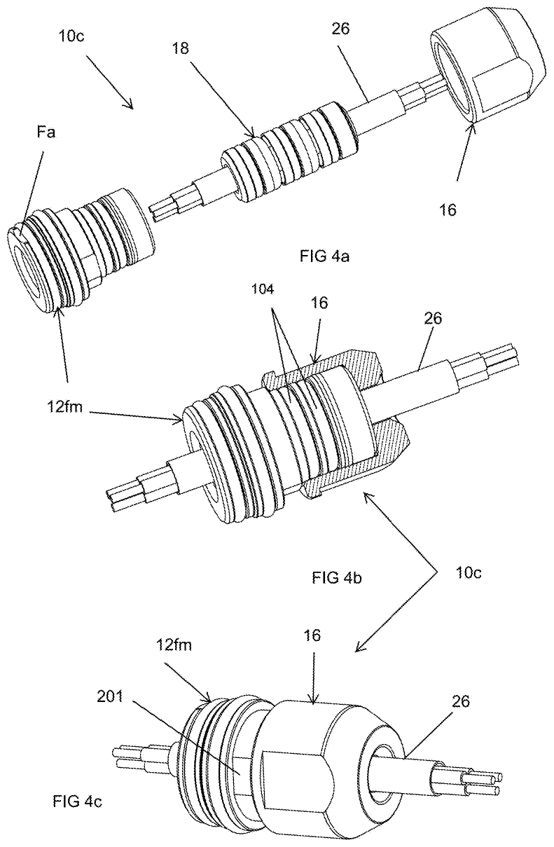

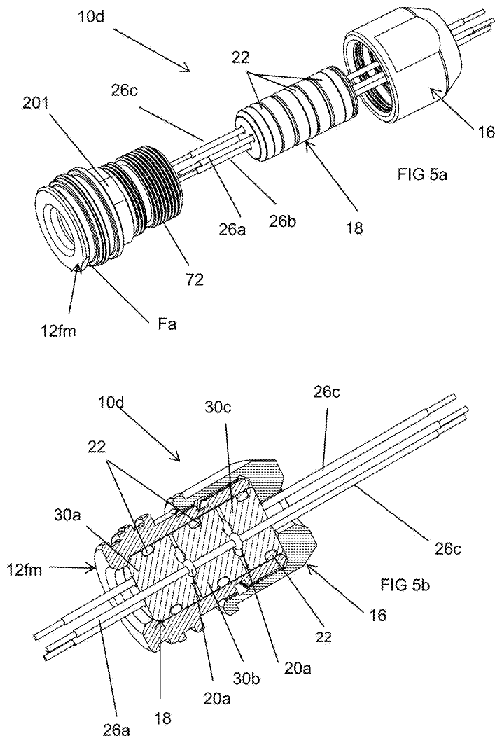

FIGS. 5a-5b show an embodiment of the gland 10d which accommodates multiple spaced apart cables 26a-26c. To accommodate multiple cables the seal assembly 18 has multiple cable seals 20a, 20b and 20c, one for each cable, between mutually adjacent carriers 30. Also, each carrier 30 is formed with multiple holes, one for each of the cables.

Looking at FIG. 5a the gland 10d accommodates a plurality, and in this example three, spaced apart cables 26a-26c. Each of these cables pass through respective spaced apart holes formed on each of the carriers 30a-30c. Between mutually adjacent carriers 30 there are three cable seals surrounding the cables 26a-26c respectively. The cable seals 20a for the cable 26a are shown in cross-section in FIG. 5b. The cable seals for the cables 26b and 26c are the same as the cable seals 20a, but are not visible. The carriers 30 have multiple compression surfaces one for each of the three cable seals.

It should be noted in this embodiment that the cable seals are located wholly within the outer radius of the adjacent carriers 30. This highlights the function of the cable seals 20 as forming a seal about the cables 26 without any requirement whatsoever to form a seal against the inner surface of the gland body 12fm. As in the previously described embodiments, each of the carriers 30 also incorporates a body seal 22 which forms a seal between the inner surface of the gland body 12fm and the outer peripheral surface of the carriers 30.

FIGS. 6a-6c show a further embodiment of the cable gland 10e. The substantive difference between cable gland 10e and the cable gland 10a is that seal assembly 18 in the cable gland 10e has only a single cable seal 20 and only two body seals 22 supported on respective carriers 30a and 30c. The carrier 30c seats an anti-rotation seal 60. The mechanism for applying longitudinal compression on the seal assembly 18 between the gland body 12fm and the nut 16 is a same as for the gland 10a. While the gland body 12fm and the nut 16 are depicted in this embodiment with screw threads 72, 87 for mutual engagement, alternate engagement mechanisms such, but not limited to, a cam lock mechanism or a press fit may be used. The gland 10e has a lower profile (i.e., shorter longitudinal length) as it has a minimum number of one cable seals 20 and two carriers 30 (carriers 30a and 30c) to form the seal assembly 18.

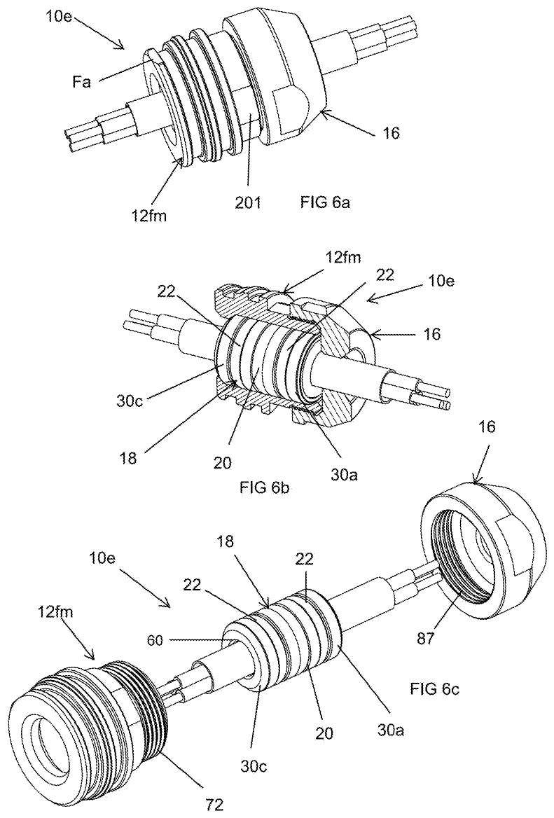

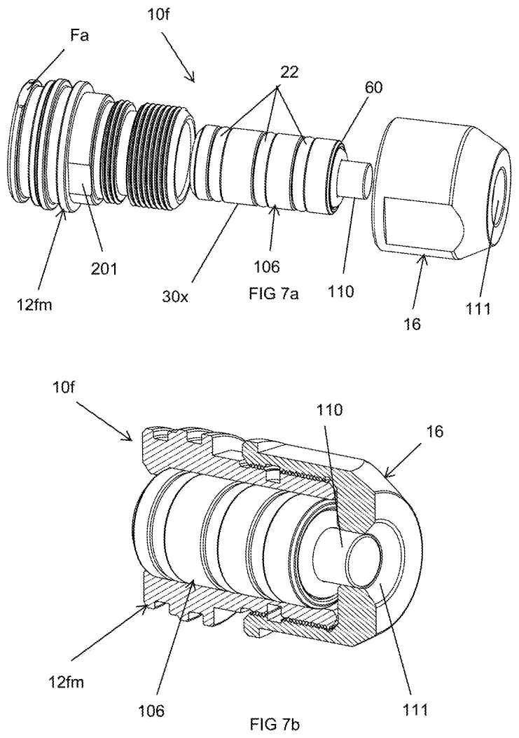

FIGS. 7a-7b and 8a-8c depict modified glands 10f and 10g respectively which are fitted with different forms of blanking plugs 106 and 108 in place of the seal assembly 18. The blanking plugs 106 for the gland 10f comprises a single carrier 30x provided with three circumferential grooves for seating respective body seals 22. The radial surface at an end of the carrier 30x adjacent the nut 16 is formed with a groove for seating an anti-rotation seal similar to previously described seal 60. A spigot 110 extends axially form one end of the plug 106. The spigot 110 is received in a hole 111 formed in the nut 16.

For the gland 10g, the blanking plug 108 is in the form of a translucent or transparent body, for example made from a plastics material. The blanking plug 108 is formed with two circumferential grooves for seating respective body seals 22, a spigot 110 at one axial end and an axial recess (not visible) at an opposite end. A groove is formed in a radial surface of the plug 108 adjacent a root of the spigot 110 for seating an anti-rotation seal similar to previously described seal 60. The spigot 110 extends through a central opening 111 in the nut 16. In use, a LED may be located in the axial recess. This enables the gland 10g to function as a sealed LED indicator.

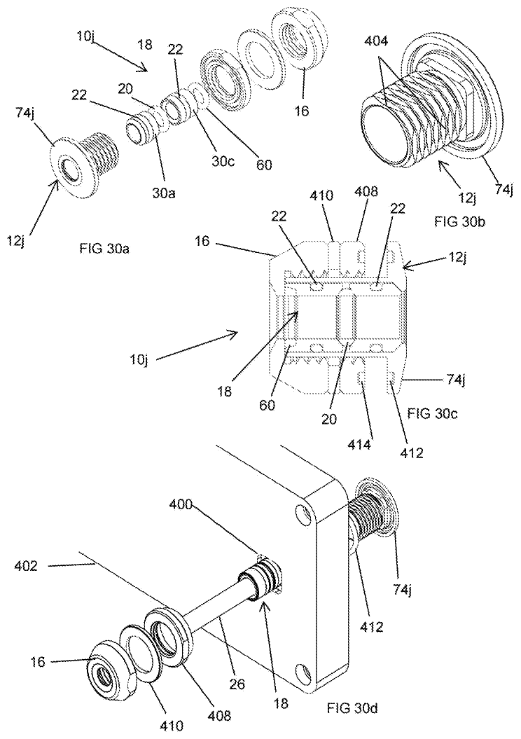

FIGS. 30a-30d show a further embodiment of the cable gland 10j. The gland 10j has a gland body 12j that is arranged to non-rotatably locate through a hole 400 in a wall 402 of enclosure such as a junction box. The gland body 12j has a threaded outer surface for receiving a nut 16. A radially extending flange 74j is formed at one end of the gland body 12j and abuts an inside surface of the enclosure. This prevents the gland 10f from being pulled out of the enclosure. The gland body 12j is also prevented from rotating within the hole 400 in the enclosure by shaping the body 12j and the hole 400 to have one or more flat surfaces that are opposite each other. In one form of this embodiment this may be achieved by forming the gland body 12j with four transversely extending flat surfaces 404 equally spaced about its longitudinal axis; and corresponding flat surfaces 406 about the hole 400. Because of this it is possible to tighten the nut 16 to apply longitudinal compression on the seal assembly 18 without the need for a tool to hold the flange 74j at one end of the gland body 12j. The cable gland 10j also has a lock nut 408, a washer 410 and seals 412 and 414 that are seated in grooves formed in surfaces of the flange 74j and the lock nut 408 respectively. The seal assembly 18 used in this embodiment has two carriers 30a and 30c as in the gland 10e with associated body seals 22, cable seal 20 and anti-rotation seal 60.

In FIG. 30d the cable gland 10j is illustrated in a first orientation where the flange 74j is on a side of the wall 402 inside of the junction box and the nut 16 is on an opposite side of the wall 402 on the outside of the junction box. In one of several alternated installation sequences, when the gland 10j is used in the first orientation, the gland body 12j is inserted through the hole 400 from the inside of the junction box. This places the flange 74j adjacent the inside surface of the wall 402 with the thread on the body 12j extending through the hole 400. The lock nut 406 is screwed onto the thread so that the seals 412 and 414 seal against opposite sides of the wall 402. The seal assembly 18 is threaded onto the cable 26 which is then passed through the body 12j from the end opposite the flange 12j. The seal assembly 18 is pushed into the gland body 12j. The washer 410 is threaded onto the cable to lie adjacent the lock nut 410, then the nut 16 is screwed onto the gland body 12j to apply longitudinal compression to, and thus activate, the seal assembly 18.

In the illustrated embodiment the seal assembly 18 has two carriers 30a and 30c as in the gland 10e. But in other forms of this embodiment the seal assembly may have three carriers 30a, 30b, 30c as in the gland 10a, or indeed more carriers 30. Also, the gland 12j can be used in a second or reverse orientation to that shown in FIG. 30d, where the flange 74j lies on the outside of the junction box with the lock nut 408, washer 410 and nut 16 on the inside of the junction box. This presents a smaller external profile which may be beneficial in some applications.

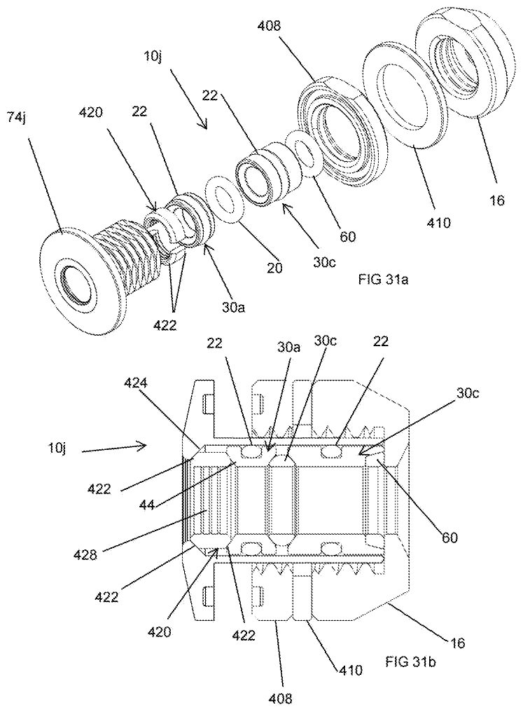

The cable retention qualities of all embodiments of the cable gland described herein, may be enhanced by the incorporation of a split clamp 420 as shown for example in FIGS. 31a and 31b. Here the clamp 420 is used in conjunction with a variant of the cable gland 10j described above and shown in FIGS. 30a-30d. In the embodiment of the cable gland 12j in FIGS. 31a and 31b, the variant is that the seal assembly 18 has carriers 30b and 30c, rather than carriers 30a and 30c. Each carrier 30a, 30c have grooves for seating body seals 22, there is a cable seal 20 between the carriers 30a, 30c and the carrier 30c seats an anti-Rotation seal 60.

The split clamp 420 is in the general form of a collar or small length tube that is split along a diametric plane. Axial opposite ends 422 of the split clamp 420 are tapered to reduce in diameter in a direction from the outer radius toward the inner radius. These tapered ends are designed to contact complementary tapered surface 424 on the gland body 12j and compression surface of 44 of carrier 30b. The split clamp 420 has a maximum outer diameter dimensioned to provide some clearance 426 within the gland body 12j, save for where the compression surface 44 of the carrier 30b contacts the tapered surface 424. An inner surface of the split clamp 420 is formed with inner circumferential ridges or teeth 428. Teeth 428 operate to grip a cable passing through the gland 10j and augment the cable retention performance.

When to gland 10j is in use and the nut 16 tightened to activate the seal assembly 12, the interaction between the opposite tapered ends 422 on the clamp 420 with the surface 424 on body 12j and surface 44 on carrier 30a, presses the clamp onto a cable passing therethrough.

The blanking plugs 106, 108, may be used to form a seal against the inner surface of the gland body 12fm by action of the body seals 22, when no cable 16 is fitted to the respective glands 10f and 10g. While the gland body 12fm and the nut 16 are depicted in both embodiments with screw threads for engagement, alternate engagement mechanism such, but not limited to, a cam lock mechanism or a press fit may be used.

In the embodiments of the gland 10a-10e the cable seals 20 are depicted in the form of O-rings with a circular central opening 24. Cable seals 20 with central openings of this configuration are appropriate for cables which have a correspondingly shaped circular cross section. However, the central opening 24 may be configured differently to accommodate cables of different profiles. This is exemplified in FIGS. 9a-9d which show a cable seal 20x; and FIGS. 10a-10d which show a cable seal 20y.

The cable seal 20x is formed with a slot like opening 24x for forming a seal about a flat cable for example of a type sometimes used in data communications. The cable seal 20y has a central opening 24y of a custom shape provided with a plurality of alternating and axially extending ridges 116 and grooves 118.

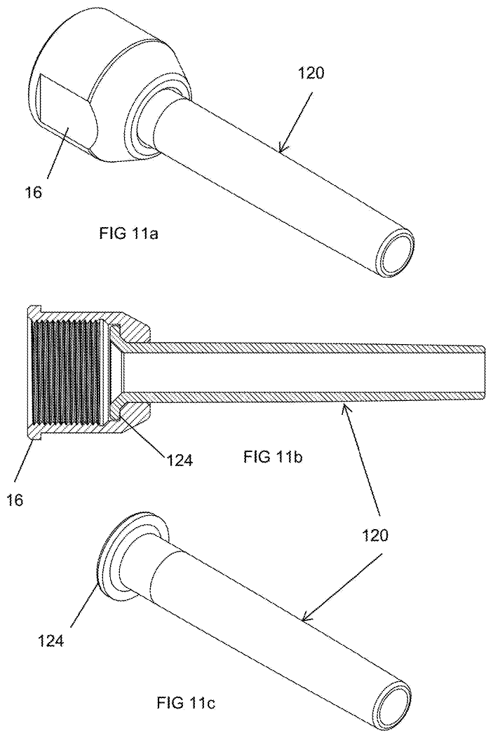

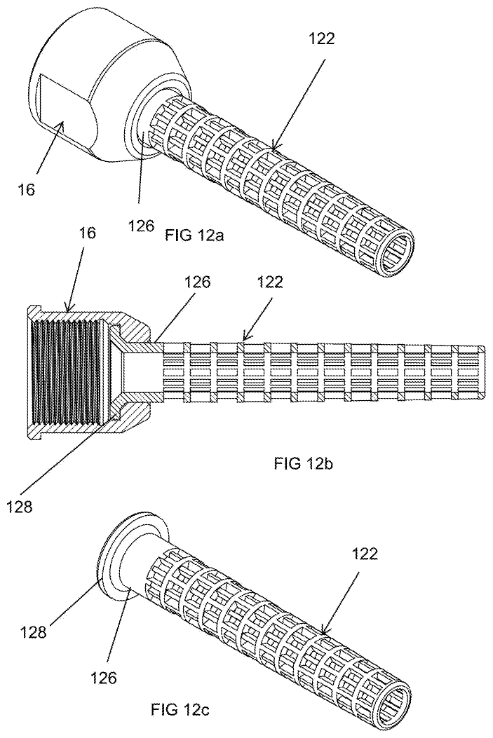

Due to the operation of the glands 10 in which only linear compression on the seal assembly 18 is required and applied, the glands 10 may be augmented by the provision of a cable relief insert 120 shown in FIGS. 11a-11c, or a cable grip insert 122 shown in FIGS. 12a-12c. The cable inserts 120, 122 may be particularly useful when the cable is subjected to articulation for example due to water currents which may otherwise cause damage to the cable at the entry to the gland 10.

The cable relief insert 120 is in the form of an elongated tube having a flange 124 at one end. The flange 124 is locked inside an associated gland between the nut 16 and the seal assembly 18 (not shown in these Figs). The cable relief insert 120 may be made from a range of materials including, but not limited to, plastics materials, or natural or synthetic rubber materials.

The cable grip insert 122 can be used to provide load bearing functionality when combined with a suitable cable. The cable grip insert 122 is in the form of an elongated wire or fibre mesh that grips the sheath of the cable 26 as the cable may flex or expand in use. The cable grip insert 122 has a collar 126 and contiguous flange 128 at one end. The flange 128 is locked inside an associated gland between the nut 16 and seal assembly 18 (not shown in these Figs). The cable grip insert 122 may be made from a range of materials including, but not limited to, rigid plastics, metals or metal alloys such stainless steel. As mentioned hereinabove, cable retention may be further enhanced by use of the split clamp 420.

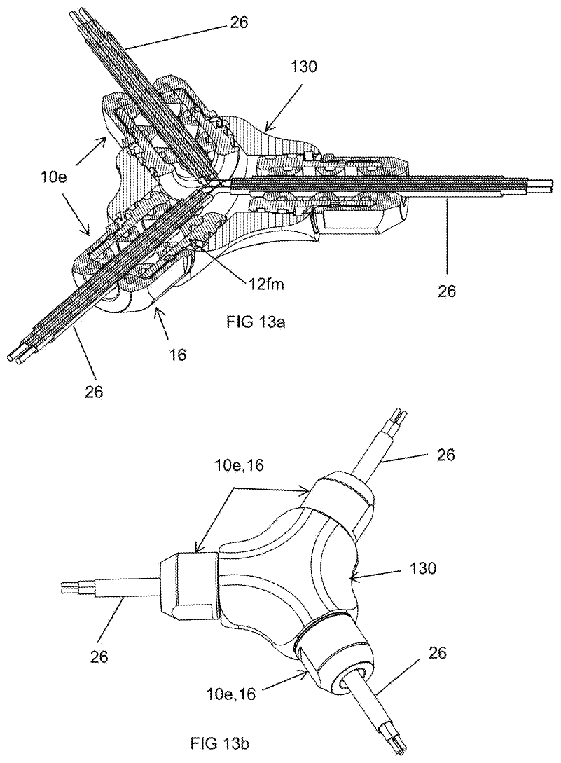

Embodiments of the disclosed gland 10 may be used in or with junction boxes of various configurations. FIGS. 13a and 13b depict use of gland 10 in a Y shaped junction box 130. The junction box 130 has three arms for receiving respective glands 10. The glands 10 may be in the form of any of the embodiments described above, though the gland embodiment 10e is shown in FIGS. 13a-13b. The respective cables 26 can be coupled to a connection block (not shown) located within the junction box 130. The glands 10e provide ingress protection about the respective cables 26. Standard ingress protection techniques are provided between the outside of the glands 10e and the junction box 130. The standard ingress protection techniques would desirably provide the same or better IP rating than the glands 10e.

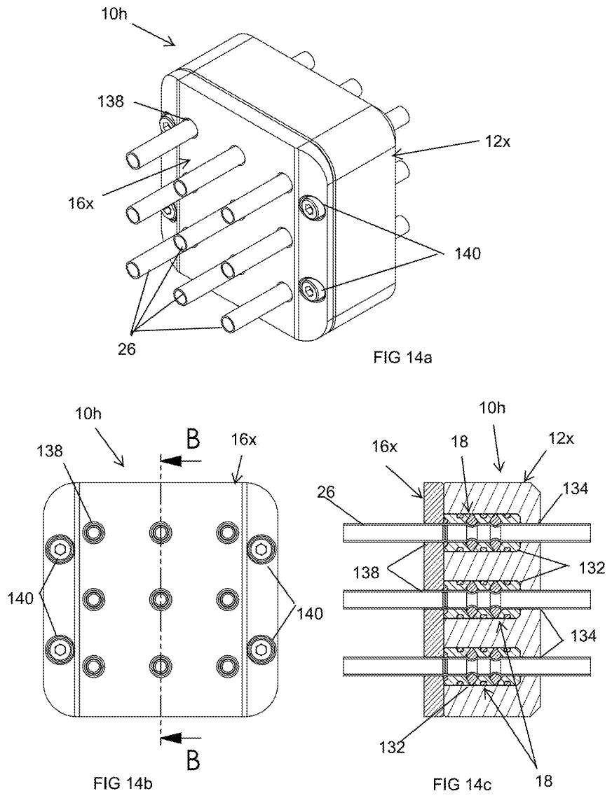

FIGS. 14a-14c illustrate an embodiment of the gland 10h where the first and second body parts are of a different configuration to the gland body 12 and nut 16 of the embodiments of the glands 10a-10g. The gland 10h is in the general form of a box having a first body part 12x and second body part 16x which are arranged to engage, or otherwise be fixed to, each other. The first body part 12x is configured as a rectangular block with a plurality of bores/passages 132 for housing respective seal assemblies 18. The bores 132 open onto one side of the part 12x. Co-axial with each bore 132 is a smaller hole 134 for passage of respective cables 26 though an opposite side of the part 12x.

The body part 16x configured as a plate arranged to engage the side of the block 12x onto which the bores 134 open. Cable bores 138 are formed in the part 16x co-axial with the bores 132 and holes 134 to allow the passage of respective cables 26.

The parts 12x and 16x can be coupled together by various mechanical arrangements. One simple mechanical arrangement is a plurality of mechanical fasteners such as nut and bolts that engage in fastener holes 140 formed in the parts 12x and 16x. The parts 12x and 16x are configured so that when they are coupled together, they apply longitudinal compression to the seal assemblies 18 housed in the bores 132. Due to this configuration the gland 10h can simultaneously accommodate and apply longitudinal compression to multiple seal assemblies 18 each of which receives a respective cable 26.

A gasket or other type of seal is provided between the parts 12x and 16x to provide water ingress protection.

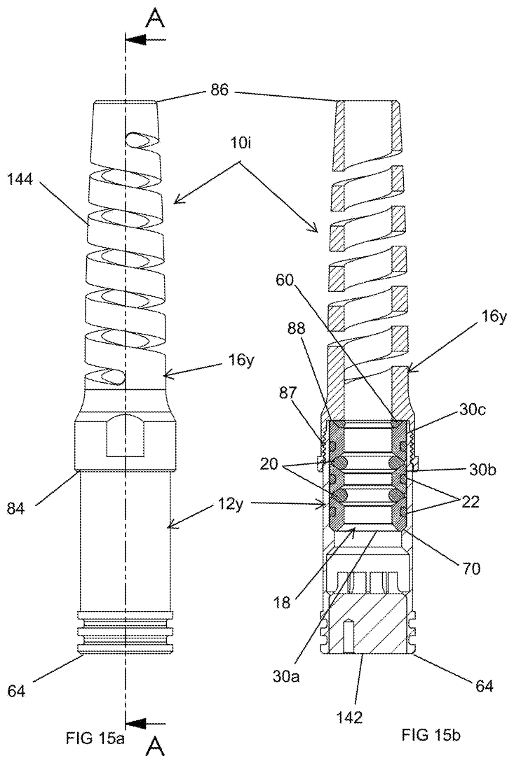

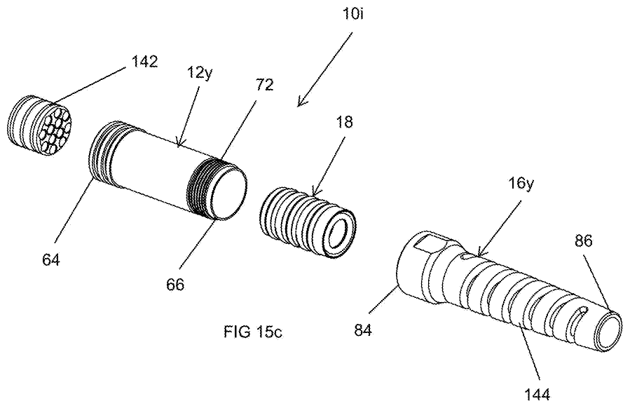

FIGS. 15a-15d illustrate yet a further embodiment of the cable gland 10i structured as waterproof cable plug, having a first part in the form of a plug body 12y and a second part 16y. The cable gland 10i has the same basic components as other cable glands namely the first and second parts 12y, 16y which are mutually engageable, and a seal assembly 18 that is housed within and between the first and second parts 12y, 16y. This embodiment differs from previous embodiments by way of the structure and configuration of the parts 12y, 16y.

The part 12y is in the form of a tubular plug body having opposite ends 64, 66 with an external thread 72 formed on its outer surface at the end 66, and an internal abutment surface 70 formed on its internal surface intermediate of the ends 64 and 66. A plug component in the form of a contact carrier 142 is seated inside the part 12y between the abutment surface 70 and the end 64. The contact carrier 142 is of no consequence to this or any other embodiment of the disclosed gland.

The part 16y is in effect the integration of nut 16 of a type similar to that shown in FIGS. 1 and 2a; and a cable relief insert similar to the cable relief insert 102 depicted in FIGS. 11a-11c. Specifically, the part 16y is formed with opposite ends 84 and 86. An internal thread 87 is formed near the end 84 for engaging the thread 72 on the part 12y. An internal abutment surface 88 is formed in the part 16y intermediate of the ends 84 and 86. For a portion from near the internal abutment surface 88 to the end 86, the part 16y is formed with a tubular spiral wound nose 144 for supporting a cable (not shown) that passes through the part 16y and the seal assembly 18. The seal assembly 18 in this embodiment is identical to that shown in FIGS. 1-2d.

When the gland 10i in a disassembled state, a cable can be passed through the nose 144 from end 86 and thereafter the carriers 30a-30c, cable seals 20 and anti-rotation seal 60 of the seal assembly 18 are threaded on the cable. The seal assembly 18 with the cable is inserted into the plug body 12y from end 66. The insertion of the seal assembly 18 is then halted by contact between the O-ring carrier 30a and the abutment surface 70 inside of the plug body 12y. The part 16y is then screwed onto plug body 12y by mutual engagement of threats 72 and 87. The threads are tightened to apply longitudinal compression to the seal assembly 18 between the abutment surfaces 70 and 88. As with all previous embodiments this longitudinal compression preferentially squeezes or deforms the cable seals 20 in a radial inward direction to form a seal about the cable passing therethrough. The body seals 22 form seals against the inner circumferential surface of the plug body 12y.

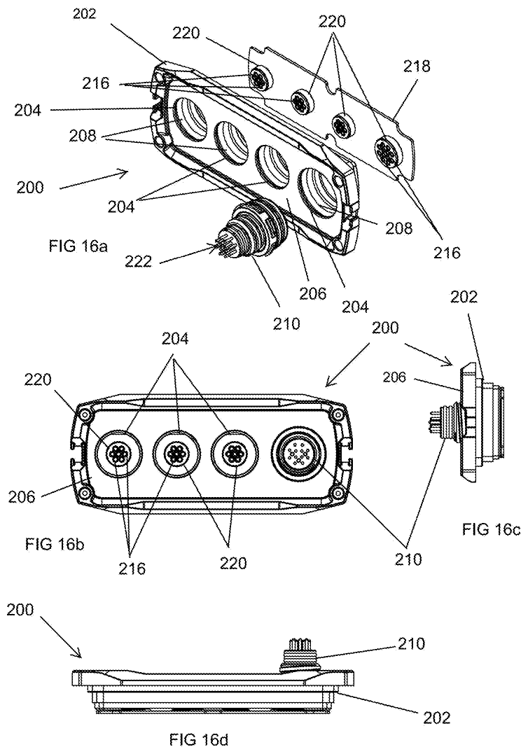

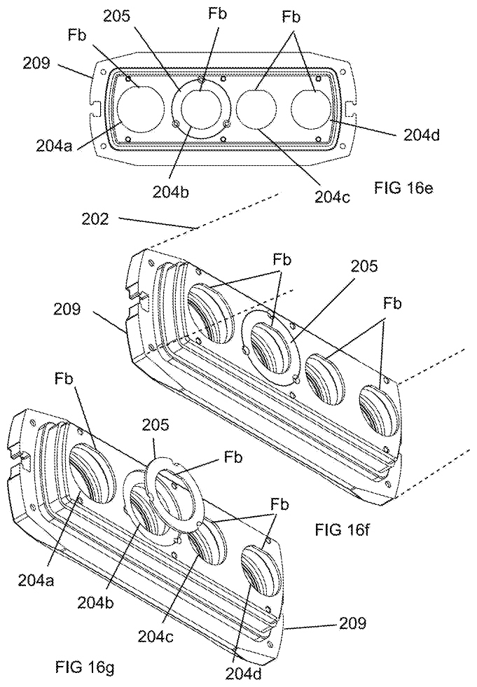

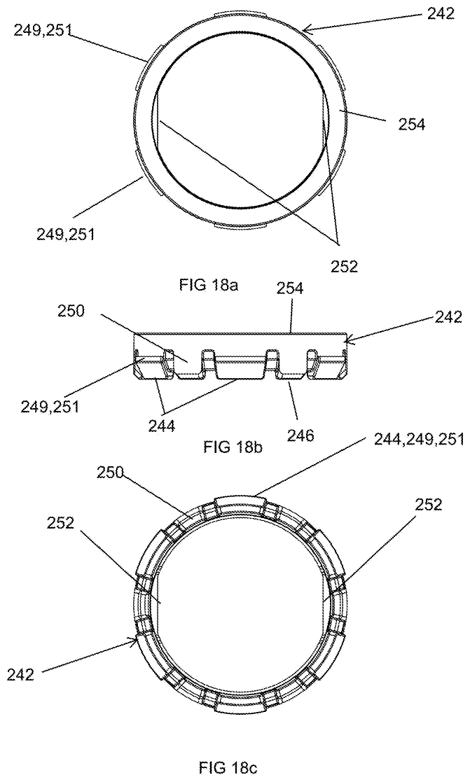

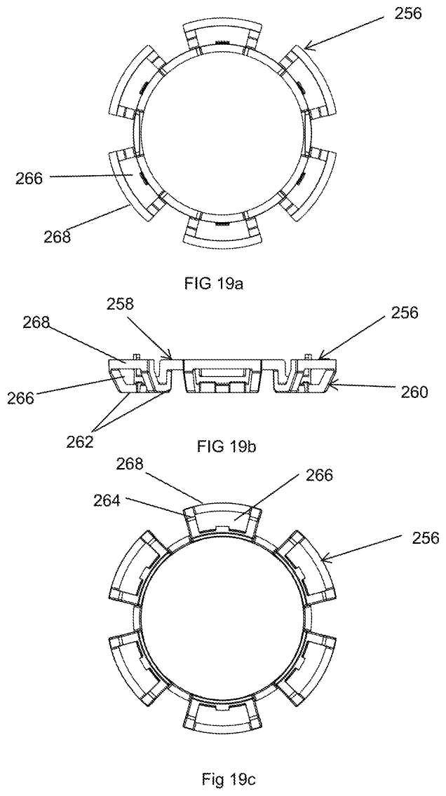

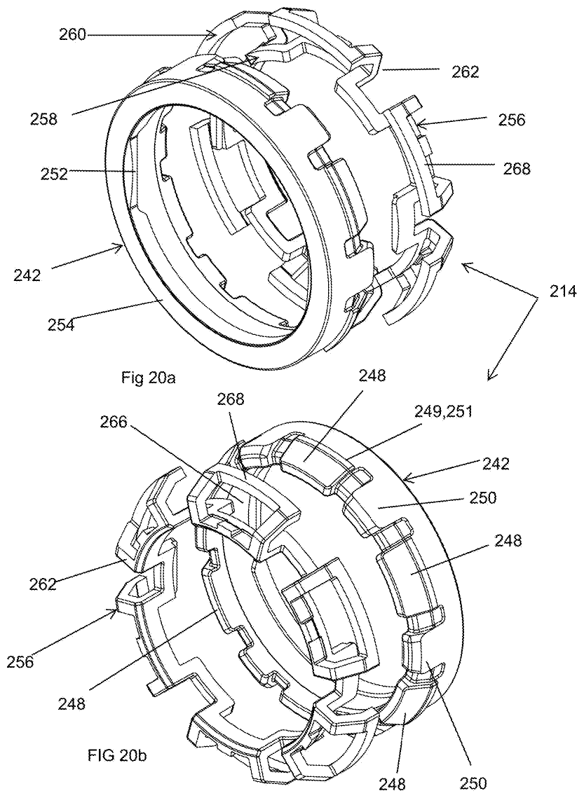

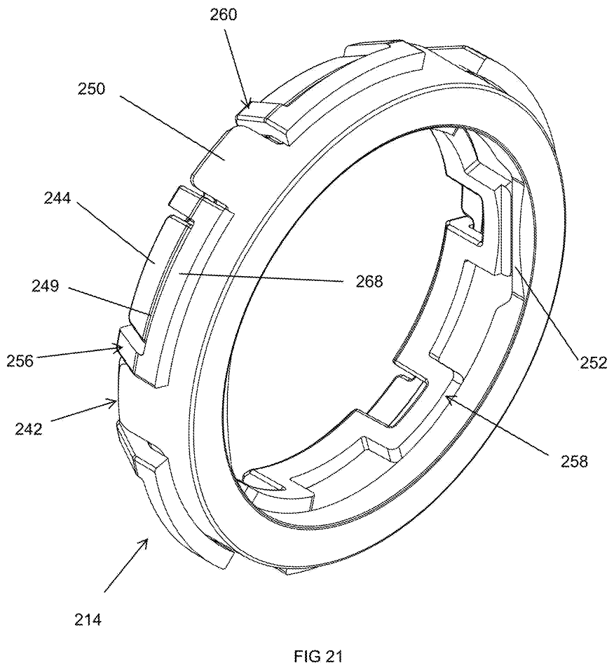

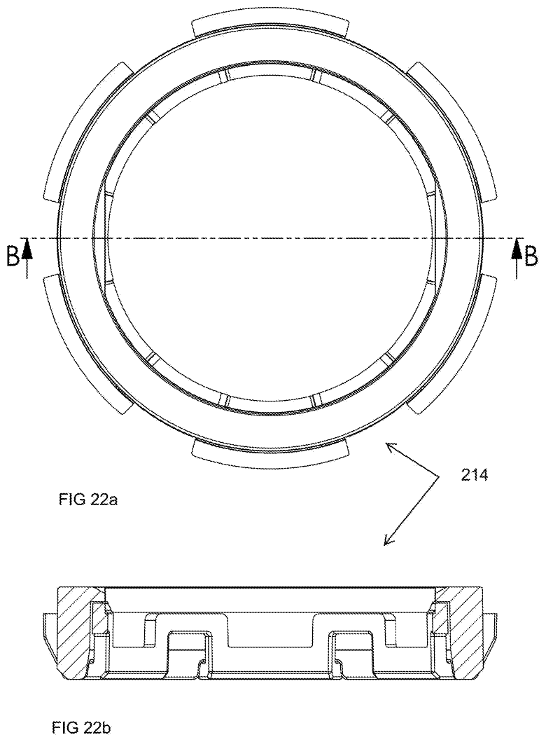

As previously mentioned, the gland body 12fm (shown in various forms in FIGS. 3b, 4b, 5b 6b) is suited to application, and incorporation, in a front mount system. An embodiment of the front mount system 200 will now be described with reference to FIGS. 16a-23c.

As will be apparent from the following description embodiments of the front mount system 200 provides a standardised way for mounting modules from the front (which can be any exterior surface) of a panel or housing in a way that allows direct connection to systems (electrical, optical, fluidic) behind the panel or inside the housing. Further benefits of the front mount system include reduced assembly time and the avoidance of loose wiring.

The front mount system 200 facilitates the making of a direct connection between one or more components (referred to as “a housing component” in the singular and “housing components” in the plural) within a closed housing 202 (shown partially and only in phantom in FIG. 16f), and one or more external components (hereinafter “external component” or “external components”) without the need to open the housing 202. More particularly the front mount system 200 enables the direct connection between connectors of housing components and connectors or external components. The components, be they housing components or external components, may include, but are not limited to, electronic equipment including printed circuit boards, sensors, optical fibres, and fluid conduits and a combination of any two or more thereof.

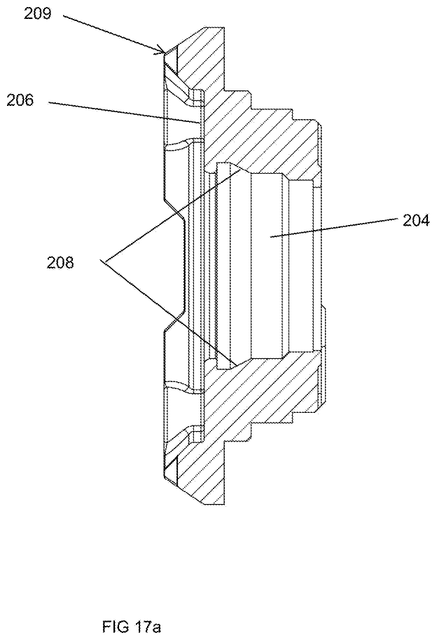

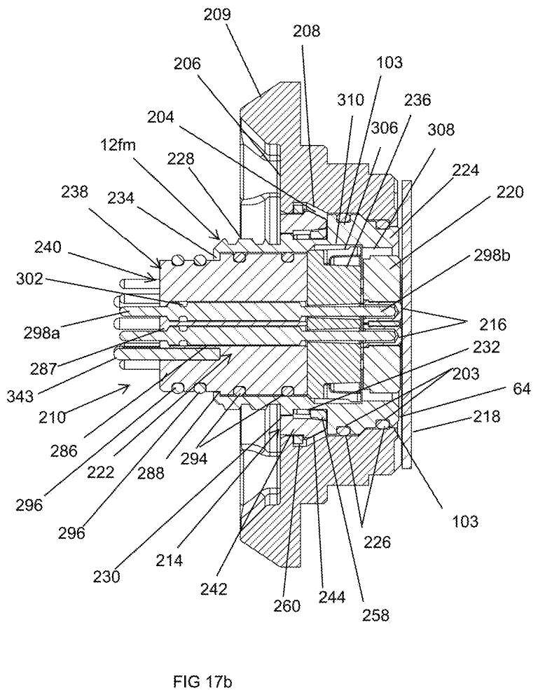

The front mount system 200 comprises several separate but operatively associated parts or structures. These include: a recess 204 that opens onto an external (or front) surface 206 of the housing 202; a circumferential channel 208 in the recess 204 and inboard of the external surface 206; a module 210 that carries connectors 222 for the external components; and a locking arrangement 214 (shown in FIGS. 17a-22d) configured to engage both the channel 208 and the module 210. The external surface 206, recesses 204 and channels 208 are parts of a front plate 209 of the housing 202.

The modules 210 may comprise or consist of sensors, plugs, sockets, cables and tubes, and are mounted to the housing 202 from the exterior surface 206 into respective recess 204 which may also be termed “ports”. The recesses may be round, rectangular, or otherwise shaped and depending on the sealing requirements (if any) the modules 210 may seat O-rings or other sealing arrangements.

A key arrangement may be incorporated to ensure there is only one possible connection orientation between the modules 210 and the recesses 204. This may be facilitated by way of: the configuration of respective connections (e.g., pins and sockets) on the modules 210 and in the recesses 204; the provision of complementary shaped surfaces on the modules and in the recesses; or the provision of other mechanical keying elements.

In FIGS. 16e-16g the key arrangement is by way of the provision of a flat surface Fb at an inside end of the recesses 204 in the front plate 209 of the housing 202. Two examples of providing the flat surface Fb are shown. In first example the flat surfaces Fb are machined or otherwise built in to the front plate 209. In particular, recess 204a, 204c and 204d, at their inside end (i.e., an end located inside the housing 202) are formed with a flat surface Fb. This matches with the flat surface Fa on the body 12fm (see FIGS. 3b, 3c, 4a, 5a, 6a, 7a, 8a). The modules with flat surfaces Fa can only be inserted in one specific rotational orientation where the surface Fa aligns and engages with to the surfaces Fb. In a second example, the recess 204b is formed with a circular inside end but fitted with a removable insert 205 formed with a flat surface Fb.

It should be appreciated that when using a key arrangement, connections between respective connectors of the modules 210 and components within the housing 202 is achieved by way of linear motion only. As a result of this it is possible to make direct electrical connections on PCB and/or fluid (i.e., for a gas or liquid) internally. This is to be contrasted with screw couplings that would require rotation of the modules 210 relative to the housing 202 to engage respective screw threads to hold the module 210 in engagement with the housing 202. This would preclude the creation of direct connections possible with use of the keyed arrangement.

As discussed later the modules 210 may be held in connection with the housing by the use of with the housing by locking arrangements implemented form the external surface 206 without the need for creating any additional penetrations into the housing 202. The locking arrangement also facilitates the removal of the modules 210 for servicing or repair without the need to create additional penetrations into the housing 202. Removal can be performed by way of a simple hand tool.

The recesses 204 may be sealed for example with a module carrying a blanking plug such as the plugs 106 and 108 described above and shown in FIGS. 7a-7b and 8a-8c when no active connection is needed.

Referring to FIGS. 17a and 17b, each recess 204 surrounds one or more contacts 216 of the housing components. For simplicity in FIG. 17b, the housing component is shown as a printed circuit board (PCB) 218 without any mounted electronic components. On a side of the PCB 218 facing the recess 204 is a fixed surface mount technology (SMT) carrier 220 which carries the contacts 216. The module 210 has a module body 12fm of a form similar to those shown in FIGS. 3b, 4b, 5b 6b which carries one or more external component connectors 222 (see FIG. 17b). In this embodiment the contacts 216 are in the form of sockets and the connectors 222 are in the form of pins, but in other embodiments this may be reversed.

The module body 12fm and the recess 204 are relatively configured to enable the module 210 to be inserted into the recess 204 by way of relative linear motion when the module 210 is in a specific rotational orientation relative to the recess 204 to connect the connectors 222 with the contacts 216 of the housing 202.

The locking arrangement 214 is configured to engage both the channel 208 and the module 210 when the contacts 216 and 222 are connected together. In this way the locking arrangement 214 acts to resist withdrawal of the module 210 from the housing 202.

The components/parts of the front mount system will now be described in more detail.

Starting with the module 210, the module has a body 12fm with a head 224 at a leading end 64 that is inserted into the recess 204. Circumferential grooves 103 are formed in the head 224 for seating O-ring seals 226. A tail portion 228 of the body 12fm has a reduced diameter in comparison to the head 224. A radially extending flange 230 is formed about the tail 228 axially spaced from the head 224. This forms circumferential recess 232. At the back of the tail 228 there is a stop 234 in the form of a radial inward flange.

Retained within the body 12fm is a lock plate 236 and contact carrier 238. The connectors 222 extend through holes in both the lock plate 236 and the contact carrier 238. The lock plate 236 locks the contact carrier 238 and the connectors 222 within the body 12fm. The combination of lock plate 236, contact carrier 238, connectors 222 and associated seals, constitute one embodiment of a field serviceable connector 240 which will be described in greater detail later in this specification.

The locking arrangement 214 comprises a ring 242 which is arranged to be located about the module body 12fm. The ring 242 has one or more locking surfaces 244 which are configured to locate within the circumferential channel 208 formed in the recess 204 of the housing 202. A leading end 246 of the ring 242 as a plurality of axially extending fingers 248. The locking surfaces 244 are located near the free ends of the fingers 248. In this embodiment the locking surfaces 244 are the form of shoulders 249 with edges 251. Mutually adjacent fingers 248 are spaced apart by respective projections 250.

The ring 242 and the module body 12fm are configured to prevent relative rotational motion between the ring and the module body when the ring is located about the module body. In this embodiment this is achieved by providing flat surfaces 252 across opposed chords on an inner diameter at a base 254 of the ring 242. The flat surfaces 252 lie in face-to-face juxtaposition with corresponding flat surfaces 201 (shown in FIGS. 3b, 4c, 5a, 6a, 7a) formed on the body 12fm.

In this, but not every, embodiment the locking arrangement 214 also includes a cage 256 which is configured to snap fit into the channel 208 and engage with the locking surfaces 244. The snap fit feature arises from the configuration and dimensions of the cage 256 and ring 242. The cage 256 has an inner structure 258 and an outer structure 260. The inner and outer structures are spaced apart and connected together by integrally formed ribs 262.

The inner structure 258 is of a configuration of a rectangular wave wrapped about an axis and joined end to end to form an endless loop. The outer structure 260 comprises a plurality of spaced apart frames 264. Each frame 264 defines an aperture 266 and has a frame member 268. The frame members 268 extend in a circumferential direction with reference to a central axis of the locking arrangement 214.

The inner and outer structures 258, 260 are able to flex toward and away from each other. This arises from a combination of the material from which the cage 256 is made and the configuration of the cage 256 itself.

The ring 242 and the cage 256 are arranged to engage each other with a snap fit in a manner that substantially prevents separation without destruction of the cage 256. To engage each other, the fingers 248 are passed into the apertures 266 of the frames 264. As this occurs the fingers bear against the frame members 268 flexing the frames 264 in a radially outward direction. This continues until the edges 251 of the shoulders 249 pass the frame members 268. When this occurs, the frames 264 snap inwardly with the frame members 268 now being nested in the shoulders 249. This engagement prevents any further inward flexing of the outer structure 260 toward the inner structure 258 which also locks the cage 256 within the channel 108 as can be seen in FIG. 17. During this insertion process the projections 250 locate between adjacent frames 264, and the O-ring seals 226 form a water tight seals against an inner surface of the recess 204.

In one way of using the locking arrangement 214, the cage 256 is initially fitted onto the tail portion 228 of the module 210 behind the head 224. The head 224 of the module 210 is then inserted into the recess 206 carrying the cage 256 with it and locating the cage 256 in the channel 208. Next the ring 242 is inserted and pressed into place, the ring 242 orientated so that the flat surfaces 201 and 252 on the module 210 the ring 242 respectively are in face to face orientation. The diameter of the channel 208 is greater than the maximum diameter of the cage 256. This provides outer structure 260 with room to flex outwardly as the ring 242 is being inserted into the recess 204 and channel 208. During the insertion process the fingers 248 enter the apertures 266, flexing the outer structure 260/frames 264 outwardly to a point is reached where frame members 268 past the edges 251 and snap back in nesting under the shoulders 249. Now the fingers 248 prevent any inward flexing of the outer structure 260 toward the inner structure 258. Thus, the entirety of the locking arrangement 214 is locked in the channel 208. During this process the connectors 222 are inserted into and thus connect with the contacts 216. Removal of the module 210 is now only possible by pulling on the module 210 with sufficient force to break the cage 256 and/or the ring 242.

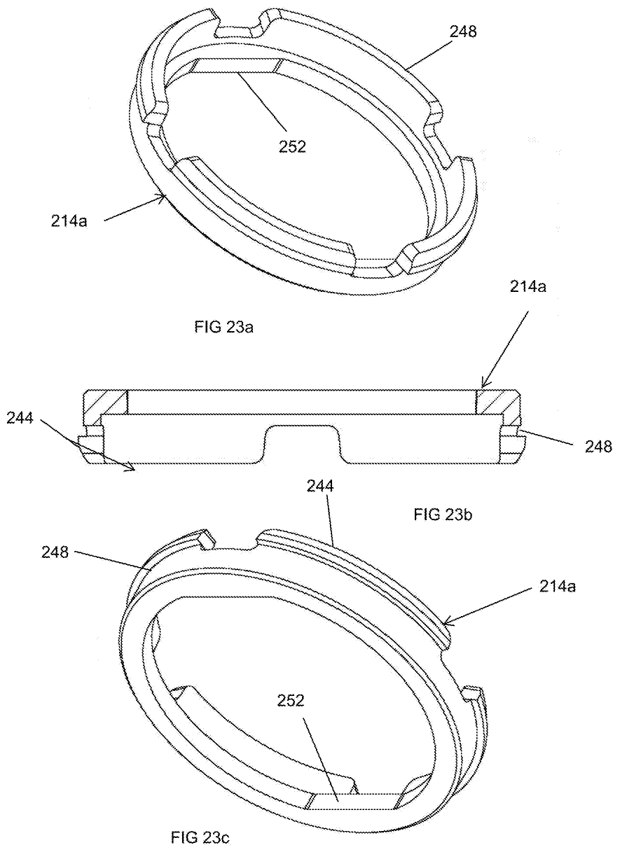

FIGS. 23a-23c depicting alternative form of locking arrangement 214a. The locking arrangement 214a requires only a single ring 242a. The ring 242a is formed with a plurality of spaced apart fingers 248. Each finger 248 is provided with a corresponding locking surface 244 of the same general configuration as a corresponding surface on the ring 242. The ring 242 also includes flat surfaces 252 for non-rotational location on a module body 12fm. Each of the fingers 248 can flex inwardly.

The locking arrangement 214a works in a similar manner to the locking arrangement 214 in that when mounted on a body 12fm which is inserted into the recess 204, the locking surfaces 244 located within a circumferential channel 208. But in this embodiment the dimensional relationship between the channel 208 and the fingers 248 is such that the fingers 248 and locking surfaces 244 snap fit directly into the channel 208.

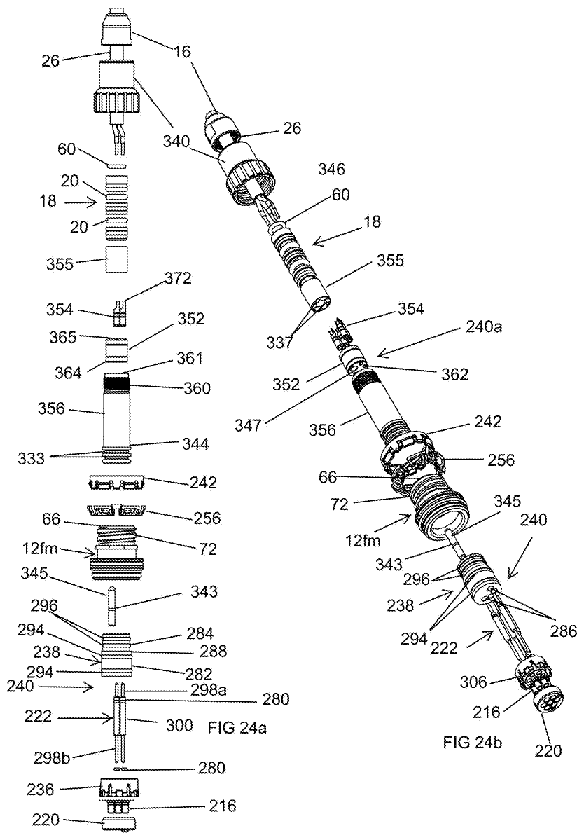

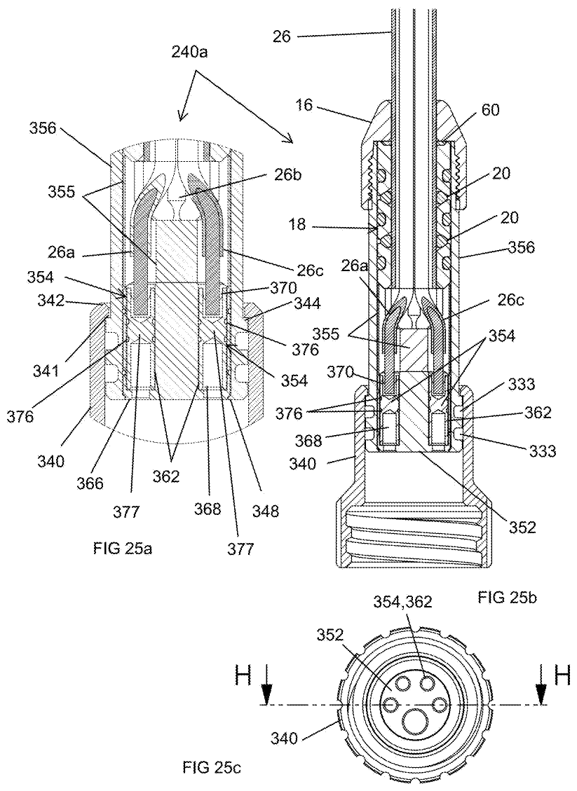

One form of the field serviceable connector 240 will now be described in greater detail with reference to FIGS. 17, 24a and 24b. A second form of the field serviceable connector 240a is also shown in FIGS. 24a and 24b, as well as FIGS. 25a-25c, but is described later.

The field serviceable connector 240 is removably held within the body 12fm and provides a watertight seal to prevent water ingress though the body 12fm. The body 12fm is similar to that shown in FIG. 5a being provided with an external thread 72. The field serviceable connector 240 includes the lock plate 236, contact carrier 238, connectors 222, and O-ring seals 280. A benefit of the field serviceable connector is that it can be disassemble and repaired or serviced on-site thereby reducing downtime and cost.

The contact carrier 238 is made of a non-conductive material and has contiguous larger and smaller diameter portions 282 and 284 respectively and formed with a plurality of through bores 286 (FIGS. 17b and 24b). The bores have a reduced diameter neck 287 in the small diameter portion 284. A shoulder 288 is formed at the junction of the larger and smaller diameter portions 282, 284. When the field serviceable connector 240 is installed in the body 12fm the shoulder 288 engaged the stop 234 (FIG. 17b). This prevents the contact carrier 238 from being pushed out of the back end 66 of the body 12fm.

Circumferential grooves are formed in the larger and smaller diameter portions 282 and 284 respectively. The grooves seat respective O-ring seals 294 and 296. The seals 294 form a water tight seal against the inside surface of the body 12fm. The seals 296 form seals against the inner surface of another body (not shown) that connects to the module 210 and may hold sensors or other devices that connect to the connectors 222.

The connectors 222 are in the general form of electrically conductive pins. The pins have opposite end portions 298a, 298b of a first diameter and an intermediate portion 300 of second greater diameter. The intermediate portions 300 reside within respective bores in the contact carrier 238. The first diameter end portions 298a and 298b extend beyond opposite ends of the contact carrier 238. The necks 287 (FIG. 17b) are of a diameter too small for the passage of the intermediate portions 300, thereby preventing the connectors 222 from being pushed out of from the small diameter portion 284. A circumferential groove 302 (visible in FIG. 17b) is formed in the intermediate portion 300 of each connector 222. Each groove 302 seats an O-ring seal 280.

The lock plate 236 is designed to snap fit into the body 12fm. The lock plate is formed with a plurality of bores through which the smaller diameter portions 298b of the connectors 222 extend. It is the portions 298b of the connectors 222 that connect with the contacts 216. The lock plate 236 includes a snap fit mechanism to facilitate a snap fit into the body 12fm. When the lock plate 236 is fitted into the body 12fm it presses against the large diameter portion 282 of the contact carrier 238.

The snap fit mechanism comprises a plurality of resilient fingers 306. The fingers 306 are designed to bend inwardly when the lock plate 236 is passing through a first inner diameter portion 308 of the body 12fm, then spring outwardly into a contiguous larger inner diameter portion 310 of the body 12fm. The fingers 306 seat in shoulder formed at the junction of the portions 308 and 310 effectively retaining the lock plate 236 and thus all other component parts of the field serviceable connector 240 in the body 12fm and module 210.

Prior to installing the lock plate 236, O-ring seals 280 are placed on the smaller diameter portions 298b of the connectors 222. These O-rings are compressed by the fitting of the lock plate 236 and form seals between the connectors 222 and the contact carrier 238.

A second embodiment of the field serviceable waterproof connector 240a (hereinafter “connector 240a”), shown in FIGS. 24a-25c can be used to facilitate connection between a cable 26 and the connectors 222. The connector 240a comprises three primary parts: a contact carrier 352; contacts 354, a connector body 356; and an optional tubular spacer 355. The spacer 355 allows passage of the cable 26 and associated wires 26a-26d, as well as also transmits the longitudinal compression across the seal assembly 18. The spacer may be provided with through holes 337 for receiving upper ends of the contacts 354.

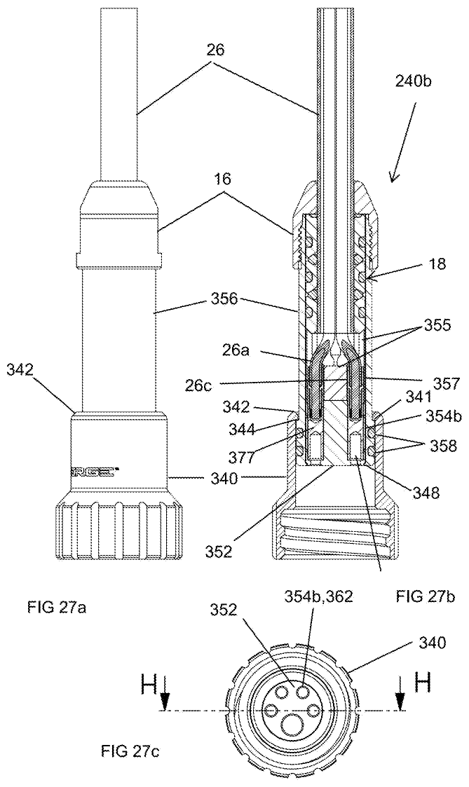

The connector body 356 has grooves 333 (FIGS. 24a, 25b) at one end for O-ring seals 358 (FIG. 27a), with an external screw thread 360 at an opposite back end 361.

Contact carrier 352 is in the form of a cylindrical block of nonconductive material having opposite ends 364 and 365 and provided with a plurality of through holes 362. At the end 364 each through hole 362 is provided with circumferential ledge 366 (shown in FIG. 25a). The contact carrier 352 is arranged to press fit into the connector body 356. The end 364 of the contact carrier 352 lies flush with the end of the connector body 356 fitted with the O-ring seals 358. The press fit between the contact carrier 352 and the connector body 356 forms a fluid seal preventing the ingress of water therebetween.

The contacts 354 in this embodiment are solder contacts. The contacts 354 are of a generally cylindrical configuration and have an outer diameter dimensioned to enable the contacts 354 to slide with close tolerance into the respective through holes 362. Each contact has a front connector 368 at one end and a back connector 370 at an opposite end. In this embodiment the front connector 368 is in the form of a socket which is adapted to connect with the end portions 298a of the connectors 222. Each back connector 370 is also general form of a socket for receiving an end of a wire. But in addition, the back connectors 370 include an integral post 372 (FIG. 24a) extending in a generally axial direction away from the front connectors 368.

In a central region 374 each contact 354 has a seal arrangement which forms a water tight seal between the contact 354 and the surface of the hole 362 in which the contact 352 resides. In this embodiment the seal arrangement is in the form of two O-ring seals 376 seated in respective circumferential grooves about the central region 374. The contacts 354, with fitted O-rings 376 are pushed into the holes 362 from the end 365 until they abut the ledges 366.

When the front connector 368 is a socket, each contact 354 is formed with a wall or plug 377 that separates the socket of front connector 368 from the socket of the back connector 370. This ensures that (a) no water can flow through the connectors 354, and (b) connectors 222 received within the front connectors 368 can directly engage with or jam against a wire fixed (for example by solder) in the back connector 370.

It should be noted however that the front connectors 368 may be in the form of pins (i.e., male connectors) rather than sockets. In that case the pins themselves would additionally act in the same manner as the wall 376. (Of course, this would also require the connectors 222 to be forms with sockets in place of the pin like end portions 298a.)

A waterproof seal may be formed between the above-mentioned cable and connector body 356 by use of a seal assembly 18 in accordance with previously described aspects of the present disclosure and as shown for example in FIGS. 1a-2e, together with a nut 16 through which the cable 26 passes. The nut 16 screws onto the thread 360 to apply longitudinal compression on the seal assembly 18 within the connector body 356 and against an internal stop or lip 348 in the connector body 356. The tubular spacer 355 is located between the contact carrier 352 and the seal assembly 18 and assists in the action of the nut 16 to affect longitudinal compression on the seal assembly 18. The collar 340 has an internal lip 341 at an end 342 (FIGS. 25a and 25b) that abuts against a rim 344 about the connector body 356. The rim 344 is inboard of the O-rings 358. An opposite end 346 of the collar 340 has an internal thread to screw onto of the thread 72 of body 12fm.

An alignment pin 343 (FIGS. 17b, 24a, 24b) is partially inserted, and fixed in, a blind hole formed in the smaller diameter portion 284 of the contact carrier 238. A projecting portion 345 of the alignment pin 343 extends from the contact carrier and is received in a hole 347 formed in the contact carrier 352, when the connector 240a is rotationally aligned with the connector 240. This results in the correct alignment, and mutual engagement of the contacts 222 and 354.

One way of assembling the connector 240a is as follows. The nut 16, seal assembly 18 and tubular spacer 355 are threaded onto the cable 26. Individual wires 26a-26d from the cable 26 may be soldered in the wire contacts 370 and/or to their corresponding posts 372. O-ring seals 376 are then seated in the circumferential grooves about each of the contacts 354. The contacts 354 are pushed into respective holes 362 from the end 365 of the contact carrier 352 until they abut the ledges 366. The collar 340 is slipped onto the connector body 356 from the back end 361 so that the lip 341 at end 346 can seat on the rim 344. The contact carrier with contacts 354, the soldered wires and the seal assembly 18 are pushed into the connector body 354 from the back end 361. The nut 16 is now engaged with and screwed onto the thread 360. This provides the longitudinal compression for activating the seal assembly 18 to form a water tight seal between the cable 26 and the connector body 356.

Thus, the internal components of the connector 240a, namely the contact carrier 352; contacts 354; seal assembly 18; and spacer 355 can be installed and removed from the backend 361.

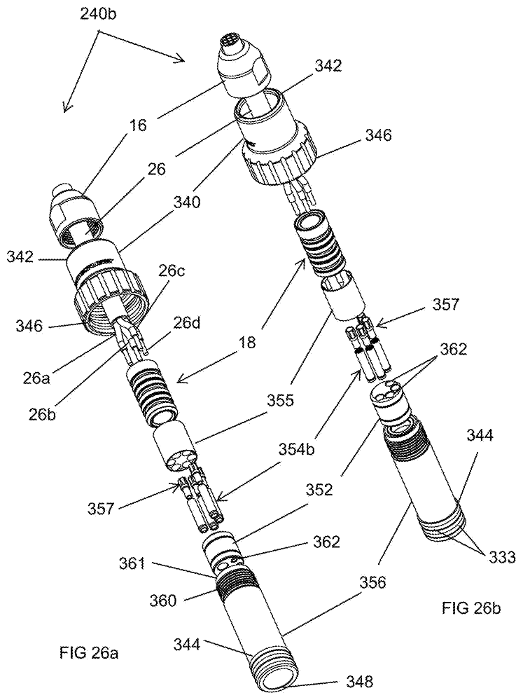

FIGS. 26a, 26b, 27a, 27b and 27c show a further embodiment of the field serviceable waterproof connector 240b (hereinafter “connector 240b”). The same reference numbers used to denote features of the 240a are used to denote the same or functionally similar features in the connector 240b. The connector 240b is very similar to the connector 240a and includes a nut 16, collar 340, seal assembly 18, contacts 354, contact carrier 352, spacer 355 and connector body 356 of the same general form and function as the equivalent features in the connector 240a. However, the connector 240b differs from the connector 240a by replacement of the contacts 354 which include the posts 372, with the combination of contacts 354b and threaded crimps 357. The contacts 354b differ from the contacts 354 by the omission of the post 372. Thus, each contact 354b is in the form of a cylindrical pin with blind sockets 368 and 370 opening at opposite ends and separated by a wall or plug 377. The threaded crimps 357 mechanically and electrically connect wires 26a-26d to respective contacts 354. The wires pass through the threaded crimps 357 which are the screwed in respective contacts 354. This squeezes the crimps 357 onto the wires while also engaging the crimps 357 with the connectors 354.

The method of assembly of the connector 240b is substantially the same as for connector 240a with the exception that the wires 26a-26d of cable 26 are connected to the contacts 354 by the crimps 357 instead of being soldered; and, there is spacer 355 is threaded onto wires 26a-26d with the seal assembly 18. As with the connector 240a, the internal components of the connector 240b (in this case: the contact carrier 352; contacts 354; and seal assembly 18 and the spacer 355) can be installed and removed from the backend 361 of the connector body 354.

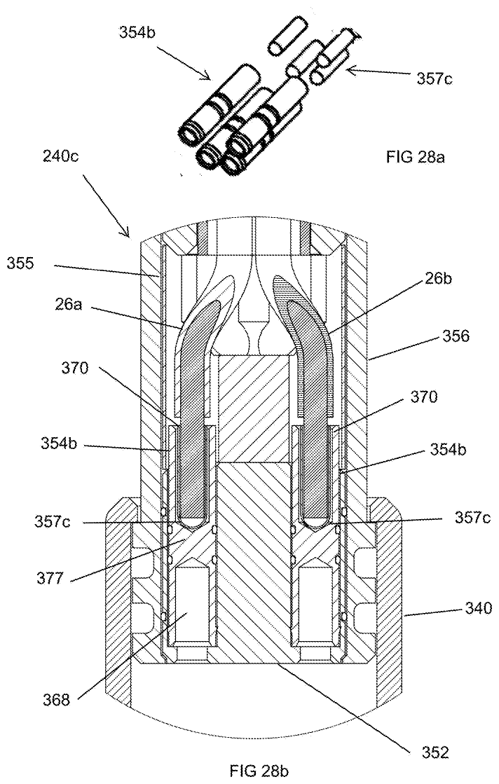

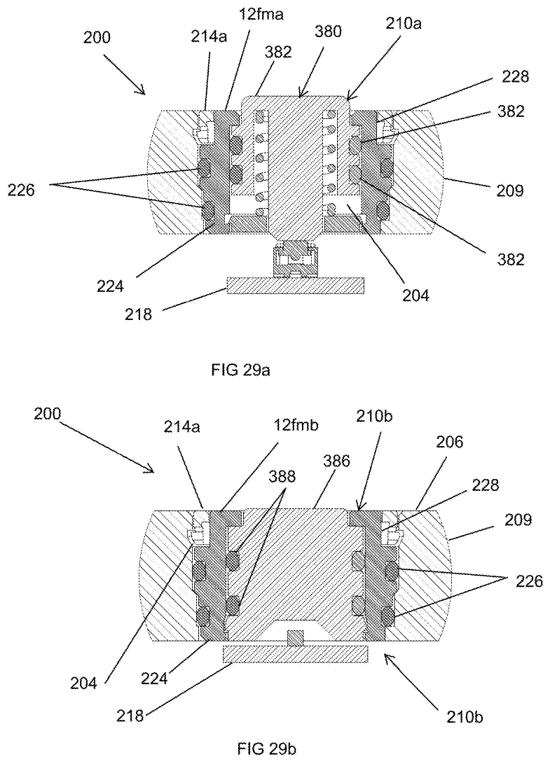

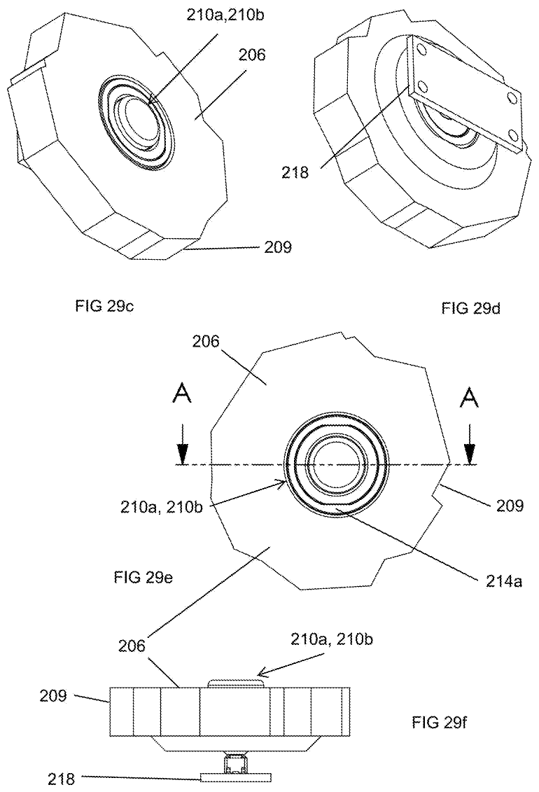

FIGS. 28a and 28b illustrate a part of an alternate form of field serviceable waterproof connector 240c. The same reference numbers used to denote features of the 240a are used to denote the same or functionally similar features in the connector 240c. The connector 240c differs from the connector 240b only by way of the replacement of the threaded crimp 357 described above with reference to FIGS. 26a-27c, with a simple sleeve crimp 357c. The sleeve crimp 357c is in the form of a tube made of an electrically conductive and plastically deformable material, such as but not limited to copper or stainless steel. The tube is dimensioned to press fit into the socket 370 of a corresponding contact 354b. The ends of wires 26a-26d are pushed into respective crimps 357c. A hand tool may then be used to press a portion of the crimp onto the inserted wire, thereby frictionally retaining the wire in the crimp. The crimp 357c with an attached wire is then inserted into a socket 370 of a contact 354b.

While several exemplary embodiments have been presented in the foregoing detailed description, it should be appreciated that a vast number of variations exist. For example, the compression surfaces 44 in the above described embodiments are in the form of opposed bevelled surfaces which mutually converge as radial distance from the cable 26 increases. However, a similar effect of squeezing the cable seal on to and about the full circumference of the cable to achieve the desired sealing effect and cable retention can be achieved by compression surfaces of different configurations. In one example one of the opposed surfaces 44 may be upright with the other of the opposed surfaces being bevelled or sloped. In this arrangement there is only one bevelled or sloped surface in a pair of opposed compression surfaces 44. Indeed, both the opposed compression surfaces can be upright for the full diameter of the carriers 30. In this case, the longitudinal compression would result in substantially uniform deformation of the cable seals 20 in opposite radial directions. It is however only the radial inward compression to provide seal contact onto and about cable 26 passing through the cable seal that is needed. It should also be appreciated that the exemplary embodiments of the waterproof cable gland are only examples, and are not intended to limit the scope, applicability, or configuration of the present disclosure in any way.

Also features of the body 12 and 12fm are interchangeable. For example, other forms of bodies may comprise the bodies 12fm shown in FIGS. 3a, 4a, having the press fit and cam lock respectively but with the grooves 103 replaced with simple screw threads 71 as per FIGS. 1a and 1b when not used is a front mount system.

Also, the body 12, 12fm may take alternate forms to that described above, the only substantive requirement is to seat the seal assembly 18 and together with a nut 16 enable the application of longitudinal compression on the seal assembly 18 while allowing the passage of a cable 26. In one possible variation the body may comprise:
a hollow tube having an outer thread, for example similar to thread 72 in FIG. 1a;
the hollow tube at one end has an internal abutment surface as per surface 70 of the body 12 in FIG. 1a;
a flange at one end of the hollow tube, the flange lying in a plane perpendicular to an axis of the hollow tube; and
a non-circular spigot formed on the flange on a side adjacent the hollow tube.

This form of body can be used for example in conjunction with a housing having a wall with non-circular hole in which the non-circular spigot form fits. The flange in face-to-face contact with wall. This may be on either side of the wall, so the body may be on the inside or outside of the housing as required for a particular application. The seal assembly with associated cable is placed inside the hollow tube, and the nut screwed onto the outer thread of the hollow tube to apply longitudinal compression to the seal assembly. Sealing may be enhanced by use of an O-ring or gasket between the flange and the wall of the housing; and an O-ring seal between the nut and the wall. Indeed, the nut may be provided with a seat for the O-ring in and about its axial end which faces the wall.

The field serviceable waterproof connector 240, 240a, 240b and 240c are described in relation to cables 26 carrying wires, i.e., electrical conductors. However, the cable 26 the cable can carry different conductors such as optical fibres to conduct light wave or conduits to conduct fluids in addition to or as an alternative to wires. This will require use of different forms of contacts 354 that conduct light or fluids, as the case may be. As the contacts are formed separately of each other the field serviceable waterproof connector can be used with a cable 26 comprising for example at least one wire, one optical fibre and one conduit; or a combination of any two of these.

FIGS. 29a-29f are representations of other forms of modules 210a, 210b that may be used in or with the disclosed front mount system 200. FIG. 29a is a section view a button activated switch module 210a and FIG. 29b is a section view a LED indicator module 210b Front and back perspective views, the plan view and a side view of the modules 210a and 210b shown in FIGS. 29c-29f, respectively are substantially the same. In these Figures only a portion of the front plate 209 is shown which includes the recess 204, front (external) surface 206 and channel 208. In each instance the modules 210a, 210b are placed directly on a printed circuit board 218, in place of the SMT contact carrier 220 shown in the embodiments of FIGS. 16a-17b.

The modules 210a, 210b have bodies 12fma and 12fmb respectively, each being of different configuration to earlier described bodies 12fm, and also of slightly different configuration to each other. Nevertheless, the bodies 12fma and 12fmb each have a head 224 with grooves for O-ring seals 226 and a tail 228. The bodies 12fma and 12fmb are held in the recesses 204 by locking arrangement 214a which may be in the same form as the ring described earlier with reference to FIGS. 23a-23c.

The button module 210a includes a sprung button 380 which snap fits into the body 12fma. The button 380 has a casing 382 that can slide within the body 12fma while retaining a water tight seal by virtue of O-rings 384 seated about the casing 382. The module 210a acts as a toggle switch to operate a device, sensor or system mounted on the PCB within the housing.

The module 210b comprises a LED within a carrier 386 snap fits into the body 12fmb. O-rings 388 provide a water tight seal between the carrier 386 and an inside surface of the body 12fmb. The condition of the LED (i.e., ON or OFF, and possibly colour) is dependent on the state of, and driven by, a device, sensor or system within the housing to which the LED module 210b is connected via the PCB 218.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the system and method as disclosed herein.

1. A waterproof cable gland comprising:
a first part and a second part, the first and second parts being mutually engageable; and
a seal assembly arranged to be housed between the first and second parts, the seal assembly having at least one cable seal and at least two carriers, each carrier provided with a body seal, wherein each cable seal is disposed between two carriers, the at least one cable seal and each carrier having respective openings through which a cable can pass, and the body seals are arranged to form seals between an associated carrier and an inner surface of the first part; and
wherein the first and second parts, when mutually engaged are configured to apply a longitudinal compression force to the seal assembly wherein the carriers squeeze a cable seal therebetween into sealing contact with and about an outer surface of a cable running through the gland.

2. The waterproof cable gland according to claim 1 wherein, each carrier has an outer circumferential groove for seating a respective body seal and at least one compression surface arranged to apply the longitudinal compression to an adjacent cable seal.

3. The waterproof cable gland according to claim 2 wherein the compression surfaces of mutually adjacent carriers between which a respective cable seal is located are relatively configured so that application of the longitudinal compressive force causes the compression surfaces of mutually adjacent carriers preferentially to compress the cable seal in a generally radially inward direction onto and surrounding the cable passing through the opening.

4. The waterproof cable gland according to claim 2 wherein facing compression surfaces of mutually adjacent carriers are configured to form a cavity for a respective cable seal, wherein the cavity has a radially outer gap and a radially inner gap wherein the radially inner gap has a greater longitudinal length than the radially outer gap.

5. The waterproof cable gland according to claim 3, wherein at least one compression surface in a pair of mutually adjacent carriers is bevelled or sloped.

6. The waterproof cable gland according to claim 5 wherein the respective mutually facing compression surfaces in a pair of mutually adjacent carriers are bevelled or sloped in a manner to converge toward each other in a direction away from the cable.

7. The waterproof cable gland according to claim 1 wherein each carrier is provided with a plurality of grooves or recesses for engaging a tool arranged to facilitate removal of the carriers from the first part.

8. The waterproof cable gland according to claim 1 including a split clamp operable to grip on the cable, wherein the split clamp is provided with tapered surfaces on opposite axial ends arranged to engage the gland body on one side and a carrier on the opposite side.

9. (canceled)

10. A method of forming a waterproof cable gland comprising:
locating a seal assembly having plurality of rigid carriers and one or more cable seals onto a cable, wherein at least one cable seal is located between mutually adjacent carriers and at least the carriers between which the at least one cable seal is located, seat respective body seals;
housing the seal assembly in and between first and second mutually engageable parts; and
longitudinally compressing the seal assembly by engaging the first and second mutually engageable parts to squeeze the at least one cable seal on to and circumferentially about the cable to form a substantial seal about the cable preventing the ingress of particles or fluid along the cable and through the gland.

11. The method according to claim 10 comprising squeezing the at least one cable seal onto the cable with sufficient force wherein the at least one cable seal frictionally grips the cable to resist a pull-out force applied to the cable.

12. A front mount system comprising a module and a housing having an external surface, the module being connectable to the housing, wherein the housing contains one or more housing components and associated housing component connectors;
the housing having a recess that opens onto the external surface and surrounds the one or more connectors;
a circumferential channel formed in the recess and inboard of the external surface;
the module having a module body containing a module component and one or more connectors of the module component, the module body and the recess relatively configured to enable the module to be inserted into the recess by way of relative linear motion when the module is in a specific rotational orientation relative to the housing to connect the one or more connectors of the module component with the one or more connectors of the housing component; and
a locking arrangement configured to engage both the channel and the module when the connectors of the module component and the housing component are connected together, the locking arrangement acting to resist withdrawal of the module from the housing.

13. The front mount system according to claim 12 wherein the locking arrangement comprises a ring arranged to be located about the module body and having one or more locking surfaces configured to locate within the channel.

14. The front mount system according to claim 13 wherein the ring and the module body are relatively configured to prevent relative rotational motion between the ring and the module body when the ring is located about the module body.

15. The front mount system according to claim 13 wherein the locking arrangement comprises a cage, the cage configured to snap fit into the channel and engage with the locking surfaces.

16. The front mount system according to claim 15 wherein the cage includes an inner structure and an outer structure spaced from the inner structure, wherein the outer structure is resiliently deformable to enable flexing of the outer structure toward and away from the inner structure and snap fitting of the cage in the channel.

17. (canceled)

18. The front mount system according to claim 16 wherein the outer structure is configured to resiliently deform to enable snap fitting of the locking arrangement within the channel.

19. The front mount system according to claim 16 wherein the ring is configured to be received between the inner and outer structures.

20. The front mount system according to claim 16 wherein the locking surfaces engage with the outer structure.

21. The front mount system according to claim 20 wherein the ring is dimensioned to prevent the outer structure from flexing toward the inner structure when the locking surfaces engage with the outer structure to an extent that would enable the cage to escape the channel, thereby locking the cage in the channel.

22. The front mount system according to claim 15 wherein one or both of the ring and the cage is a sacrificial component arranged to break on application of a tensile force of a magnitude greater than a threshold breaking force.

23-28. (canceled)
